(19) United States
(12) Patent Application Publication
(10) Pub. No.: US 2026/0239116 A1
(43) Pub. Date: Aug. 13, 2026

(54) BEAM PREDICTION ASPECTS DURING HANDOVER

(71) Applicant: Nokia Technologies Oy, Espoo (FI)

(72) Inventors: Amaanat ALI, Espoo (FI); Keeth Saliya Jayasinghe LADDU, Espoo (FI)

(21) Appl. No.: 19/473,053

(22) PCT Filed: Apr. 17, 2024
(86) PCT No.: PCT/EP2024/060370

§ 371 Date: Oct. 6, 2025

Related U.S. Application Data
(60) Provisional application No. 63/469,081, filed on May 26, 2023.

(51) Int. Cl. H04W 36/00; H04B 17/318; H04L 41/16

(52) U.S. Cl. CPC H04W 36/0058; H04B 17/328; H04L 41/16

(57) ABSTRACT

An apparatus configured to: receive, from a source cell, a handover command, wherein the handover command comprises: at least one handover condition, and a configuration for machine learning model monitoring and reporting; monitor one or more machine learning functionality configurations for at least one target cell based, at least partially, on the configuration for machine learning model monitoring and reporting; evaluate the one or more machine learning functionality configurations based, at least partially, on the monitoring of the one or more machine learning functionality configurations; and determine at least one configuration for performing handover based, at least partially, on the evaluating of the one or more machine learning functionality configurations, wherein the at least one determined configuration for performing handover comprises one of: a non-machine learning configuration, or at least one machine learning functionality configuration of the one or more machine learning functionality configurations.

### CROSS REFERENCE TO RELATED APPLICATION

This application claims the benefit of U.S. provisional application No. 63/469,081 filed 26 May 2023, which is incorporated herein by reference in its entirety.

### TECHNICAL FIELD

The example and non-limiting embodiments relate generally to handover (HO) and, more particularly, to UE measurements and machine learning (ML) model functionality monitoring during the conditional handover (CHO) execution phase.

### BACKGROUND

It is known, in cellular communication, that there are some discussions to augment the air-interface with AI/ML-based algorithms.

### SUMMARY

The following summary is merely intended to be illustrative. The summary is not intended to limit the scope of the claims.

In accordance with one aspect, an apparatus comprising: at least one processor; and at least one memory storing instructions that, when executed by the at least one processor, cause the apparatus at least to: receive, from a source cell, a handover command, wherein the handover command comprises: at least one handover condition, and a configuration for machine learning model monitoring and reporting; monitor one or more machine learning functionality configurations for at least one target cell based, at least partially, on the configuration for machine learning model monitoring and reporting; evaluate the one or more machine learning functionality configurations based, at least partially, on the monitoring of the one or more machine learning functionality configurations; and determine at least one configuration for performing handover based, at least partially, on the evaluating of the one or more machine learning functionality configurations, wherein the at least one determined configuration for performing handover comprises one of: a non-machine learning configuration, or at least one machine learning functionality configuration of the one or more machine learning functionality configurations.

In accordance with one aspect, a method comprising: receiving, with a user equipment from a source cell, a handover command, wherein the handover command comprises: at least one handover condition, and a configuration for machine learning model monitoring and reporting; monitoring one or more machine learning functionality configurations for at least one target cell based, at least partially, on the configuration for machine learning model monitoring and reporting; evaluating the one or more machine learning functionality configurations based, at least partially, on the monitoring of the one or more machine learning functionality configurations; and determining at least one configuration for performing handover based, at least partially, on the evaluating of the one or more machine learning functionality configurations, wherein the at least one determined configuration for performing handover comprises one of: a non-machine learning configuration, or at least one machine learning functionality configuration of the one or more machine learning functionality configurations.

In accordance with one aspect, an apparatus comprising means for: receiving, from a source cell, a handover command, wherein the handover command comprises: at least one handover condition, and a configuration for machine learning model monitoring and reporting; monitoring one or more machine learning functionality configurations for at least one target cell based, at least partially, on the configuration for machine learning model monitoring and reporting; evaluating the one or more machine learning functionality configurations based, at least partially, on the monitoring of the one or more machine learning functionality configurations; and determining at least one configuration for performing handover based, at least partially, on the evaluating of the one or more machine learning functionality configurations, wherein the at least one determined configuration for performing handover comprises one of: a non-machine learning configuration, or at least one machine learning functionality configuration of the one or more machine learning functionality configurations.

In accordance with one aspect, a non-transitory computer-readable medium comprising program instructions stored thereon for performing at least the following: causing receiving, from a source cell, of a handover command, wherein the handover command comprises: at least one handover condition, and a configuration for machine learning model monitoring and reporting; monitoring one or more machine learning functionality configurations for at least one target cell based, at least partially, on the configuration for machine learning model monitoring and reporting; evaluating the one or more machine learning functionality configurations based, at least partially, on the monitoring of the one or more machine learning functionality configurations; and determining at least one configuration for performing handover based, at least partially, on the evaluating of the one or more machine learning functionality configurations, wherein the at least one determined configuration for performing handover comprises one of: a non-machine learning configuration, or at least one machine learning functionality configuration of the one or more machine learning functionality configurations.

In accordance with one aspect, an apparatus comprising: at least one processor; and at least one memory storing instructions that, when executed by the at least one processor, cause the apparatus at least to: transmit, to at least one target cell, a handover request; receive, from the at least one target cell, an acknowledgement of the handover request, wherein the acknowledgement comprises, at least one of: an indication of one or more resources for monitoring one or more machine learning functionality configurations, or an indication of a criteria for evaluating the one or more machine learning functionality configurations; determine a configuration for machine learning model monitoring and reporting based, at least partially, on the acknowledgement of the handover request; and transmit, to a user equipment, a handover command, wherein the handover command comprises: at least one handover condition, and the configuration for machine learning model monitoring and reporting.

In accordance with one aspect, a method comprising: transmitting, with a source base station to at least one target cell, a handover request; receiving, from the at least one target cell, an acknowledgement of the handover request, wherein the acknowledgement comprises, at least one of: an indication of one or more resources for monitoring one or more machine learning functionality configurations, or an indication of a criteria for evaluating the one or more machine learning functionality configurations; determining a configuration for machine learning model monitoring and reporting based, at least partially, on the acknowledgement of the handover request; and transmitting, to a user equipment, a handover command, wherein the handover command comprises: at least one handover condition, and the configuration for machine learning model monitoring and reporting.

In accordance with one aspect, an apparatus comprising means for: transmitting, to at least one target cell, a handover request; receiving, from the at least one target cell, an acknowledgement of the handover request, wherein the acknowledgement comprises, at least one of: an indication of one or more resources for monitoring one or more machine learning functionality configurations, or an indication of a criteria for evaluating the one or more machine learning functionality configurations; determining a configuration for machine learning model monitoring and reporting based, at least partially, on the acknowledgement of the handover request; and transmitting, to a user equipment, a handover command, wherein the handover command comprises: at least one handover condition, and the configuration for machine learning model monitoring and reporting.

In accordance with one aspect, a non-transitory computer-readable medium comprising program instructions stored thereon for performing at least the following: causing transmitting, to at least one target cell, of a handover request; causing receiving, from the at least one target cell, of an acknowledgement of the handover request, wherein the acknowledgement comprises, at least one of: an indication of one or more resources for monitoring one or more machine learning functionality configurations, or an indication of a criteria for evaluating the one or more machine learning functionality configurations; determining a configuration for machine learning model monitoring and reporting based, at least partially, on the acknowledgement of the handover request; and causing transmitting, to a user equipment, of a handover command, wherein the handover command comprises: at least one handover condition, and the configuration for machine learning model monitoring and reporting.

In accordance with one aspect, an apparatus comprising: at least one processor; and at least one memory storing instructions that, when executed by the at least one processor, cause the apparatus at least to: receive, from a source cell, a handover request; and transmit, to the source cell, an acknowledgement of the handover request, wherein the acknowledgement comprises, at least one of: an indication of one or more resources for monitoring one or more machine learning functionality configurations, or an indication of a criteria for evaluating the one or more machine learning functionality configurations.

In accordance with one aspect, a method comprising: receiving, with a target base station from a source cell, a handover request; and transmitting, to the source cell, an acknowledgement of the handover request, wherein the acknowledgement comprises, at least one of: an indication of one or more resources for monitoring one or more machine learning functionality configurations, or an indication of a criteria for evaluating the one or more machine learning functionality configurations.

In accordance with one aspect, an apparatus comprising means for: receiving, from a source cell, a handover request; and transmitting, to the source cell, an acknowledgement of the handover request, wherein the acknowledgement comprises, at least one of: an indication of one or more resources for monitoring one or more machine learning functionality configurations, or an indication of a criteria for evaluating the one or more machine learning functionality configurations.

In accordance with one aspect, a non-transitory computer-readable medium comprising program instructions stored thereon for performing at least the following: causing receiving, from a source cell, of a handover request; and causing transmitting, to the source cell, of an acknowledgement of the handover request, wherein the acknowledgement comprises, at least one of: an indication of one or more resources for monitoring one or more machine learning functionality configurations, or an indication of a criteria for evaluating the one or more machine learning functionality configurations.

According to some aspects, there is provided the subject matter of the independent claims. Some further aspects are defined in the dependent claims.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a flowchart illustrating steps as described herein;

FIG. 3 is a diagram illustrating features as described herein;

FIG. 4 is a diagram illustrating features as described herein;

FIG. 5 is a diagram illustrating features as described herein;

FIG. 6A and FIG. 6B are a flowchart illustrating steps as described herein;

FIG. 7 is a flowchart illustrating steps as described herein;

FIG. 8 is a flowchart illustrating steps as described herein; and

FIG. 9 is a flowchart illustrating steps as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
ACK acknowledgement
AI artificial intelligence
AMF access and mobility management function
BM beam management
CHO conditional handover
CSI channel state information
CRAN cloud radio access network
CU central unit
DL downlink
DU distributed unit
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
HO handover
I/F interface
KPI key performance indicator
L1 layer 1
LTE long term evolution
MAC medium access control
MI machine learning
MME mobility management entity
ng or NG new generation
ng-eNB or NG-eNB new generation eNB
NN neural network
NR new radio
N/W or NW network
O-RAN open radio access network
PDCP packet data convergence protocol
PHY physical layer
PRACH physical random access channel
QoS quality of service
RACH random access channel
RAN radio access network
RF radio frequency
RLC radio link control
RLF radio link failure
RRC radio resource control
RRH remote radio head
RS reference signal
RSRP reference signal received power
RU radio unit
Rx receiver
SDAP service data adaptation protocol
SGW or S-GW serving gateway
SI study item
SMF session management function
SN sequence number
SSB synchronization signal block
TTT time to trigger
Tx transmitter
UE user equipment (e.g., a wireless, typically mobile device)
UPF user plane function
VNR virtualized network function
WI work item

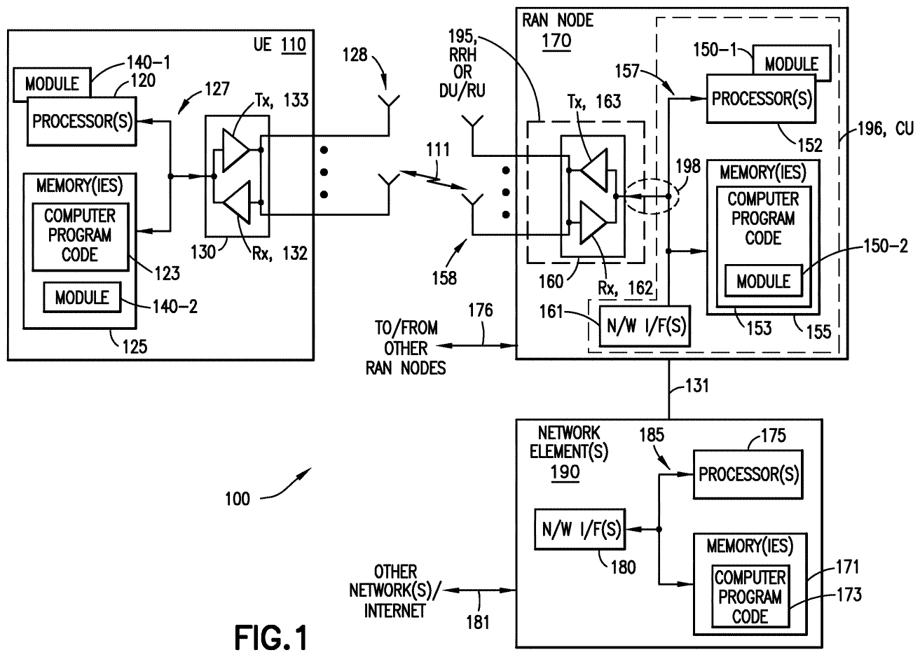

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. A “circuit” may include dedicated hardware or hardware in association with software executable thereon. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station, access point, access node, or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g., a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. For example, a network may be deployed in a tele cloud, with virtualized network functions (VNF) running on, for example, data center servers. For example, network core functions and/or radio access network(s) (e.g. CloudRAN, O-RAN, edge cloud) may be virtualized. Note that the virtualized entities that result from the network virtualization are still implemented, at some level, using hardware such as processors 152 or 175 and memories 155 and 171, and also such virtualized entities create technical effects.

It may also be noted that operations of example embodiments of the present disclosure may be carried out by a plurality of cooperating devices (e.g. cRAN).

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the example embodiments of the present disclosure, example embodiments will now be described with greater specificity.

Features as described herein may generally relate to artificial intelligence (AI) and/or machine learning (ML). The Rel-18 Study Item (SI) on Artificial Intelligence (AI)/Machine Learning (ML) for NR Air Interface [3GPP RP-213599] aims at exploring the benefits of augmenting the air interface with features enabling support of AI/ML-based algorithms for enhanced performance and/or reduced complexity/overhead. This SI's target is to lay the foundation for future air-interface use cases leveraging AI/ML techniques. The initial set of use cases to be covered include channel state information (CSI) feedback enhancement (e.g. overhead reduction using CSI compression, improved accuracy, prediction), beam management (e.g. beam prediction in time and/or spatial domain for overhead and latency reduction, beam selection accuracy improvement), and positioning accuracy enhancements. For those use cases the benefits may be evaluated (e.g. utilizing developed methodology and defined KPIs), and the potential impact on the specifications may be assessed, including PHY layer aspects and/or protocol aspects.

One of the key expected outcomes of the SI is “The AI/ML approaches for the selected sub use cases need to be diverse enough to support various requirements on the gNB-UE collaboration levels.”

It may be noted that in the work item (WI) phase of “AI/ML for air interface”, other use cases might also be addressed. Starting from Release 18, it is very likely companies will propose a large variety of use cases and applications of ML in the gNB and UE. The goal of the WI is to explore the benefits of augmenting the air-interface with features enabling improved support of AI/ML-based algorithms for enhanced performance and/or reduced complexity/overhead. Enhanced performance depends on the considered use cases and may include, for example, improved throughput, robustness, accuracy or reliability, etc. The goal is that sufficient use cases may be considered to enable the identification of a common AI/ML framework, including functional requirements of AI/ML architecture, which may be used in subsequent projects. The study may also identify areas where AI/ML may improve the performance of air-interface functions. Specification impact may be assessed in order to improve the overall understanding of what would be required to enable AI/ML techniques for the air interface.

Features as described herein may generally relate to one or more AI/ML models. For example, an AI/ML model(s) may be located with each of a UE and a base station (e.g. split between multiple nodes, or a separate model at each node). Alternatively, an AI/ML model may be located with one of a UE or a base station.

An example of an AI/ML model is a neural network. A neural network (NN) is a computation graph consisting of two or more layers of computation. Each layer may consist of one or more units, where each unit may perform an elementary computation. A unit may be connected to one or more other units, and the connection may have a weight associated with it. The weight may be used for scaling the signal passing through the associated connection. Weights may be learnable parameters, i.e., values which can be learned from training data. There may be other learnable parameters, such as those of batch-normalization layers.

Two of the most widely used architectures for neural networks are feed-forward and recurrent architectures. Feed-forward neural networks do not comprise a feedback loop; each layer takes input from one or more of the previous layers and provides output, which is used as the input for one or more of the subsequent layers. Units within a layer take input from unit(s) in one or more preceding layers, and provide output to unit(s) of one or more following layers.

Initial layers, i.e. layers close to the input data, extract semantically low-level features from received data, and intermediate and final layers extract more high-level features. After the feature extraction layers there may be one or more layers performing a certain task, such as classification, semantic segmentation, object detection, denoising, style transfer, super-resolution, etc. In recurrent neural networks, there is a feedback loop, so that the network becomes stateful, i.e., it is able to memorize or retain information or a state.

Neural networks may be utilized in an ever increasing number of applications for many different types of device, such as mobile phones, as described above. Examples of applications may include image and video analysis and processing, social media data analysis, device usage data analysis, etc.

Neural networks, and other machine learning tools, may be able to learn properties from input data, either in a supervised way or in an unsupervised way. Such learning may be the result of a training algorithm, or of a meta-level neural network providing a training signal.

A training algorithm may consist of changing some properties of the neural network so that the output of the neural network is as close as possible to a desired output. Training may comprise changing properties of the neural network so as to minimize or decrease the output's error, also referred to as the loss. Examples of losses include mean squared error (MSE), cross-entropy, etc. In recent deep learning techniques, training is an iterative process, where, at each iteration, the algorithm modifies the weights of the neural network to make a gradual improvement of the network's output, i.e., to gradually decrease the loss.

Training a neural network comprises an optimization process, but the final goal of machine learning is different from the typical goal of optimization. In optimization, the goal is to minimize loss. In machine learning generally, in addition to the goal of optimization, the goal is to make the model learn the properties of the data distribution from a limited training dataset. In other words, the training process is additionally used to ensure that the neural network learns to use a limited training dataset in order to learn to generalize to previously unseen data, i.e., data which was not used for training the model. This additional goal is usually referred to as generalization. In practice, data may be split into at least two sets, the training set and the validation set. The training set may be used for training the network, i.e., for modification of its learnable parameters in order to minimize the loss. The validation set may be used for checking the performance of the neural network with data which was not used to minimize the loss (i.e. which was not part of the training set), where the performance of the neural network with the validation set may be an indication of the final performance of the model. The errors on the training set and on the validation set may be monitored during the training process to understand if the neural network is learning at all and if the neural network is learning to generalize. In the case that the network is learning at all, the training set error should decrease. If the network is not learning, the model may be in the regime of underfitting. In the case that the network is learning to generalize, validation set error should decrease and not be much higher than the training set error. If the training set error is low, but the validation set error is much higher than the training set error, or the validation set error does not decrease, or it even increases, the model may be in the regime of overfitting. Overfitting may mean that the model has memorized the training set's properties and performs well only on that set, but performs poorly on a set not used for tuning its parameters. In other words, the model has not learned to generalize.

In the present description, the terms “model”, “AI model”, and “ML model” may be interchanged with each other; where an example embodiment is described with reference to one type of model, another type of model may be substituted. In the present description, the terms “ML-enabled function”, “ML functionality”, “AI-enabled function”, “AI functionality”, “AI/ML-enabled function”, and “AI/ML functionality” may be interchanged with each other as well.

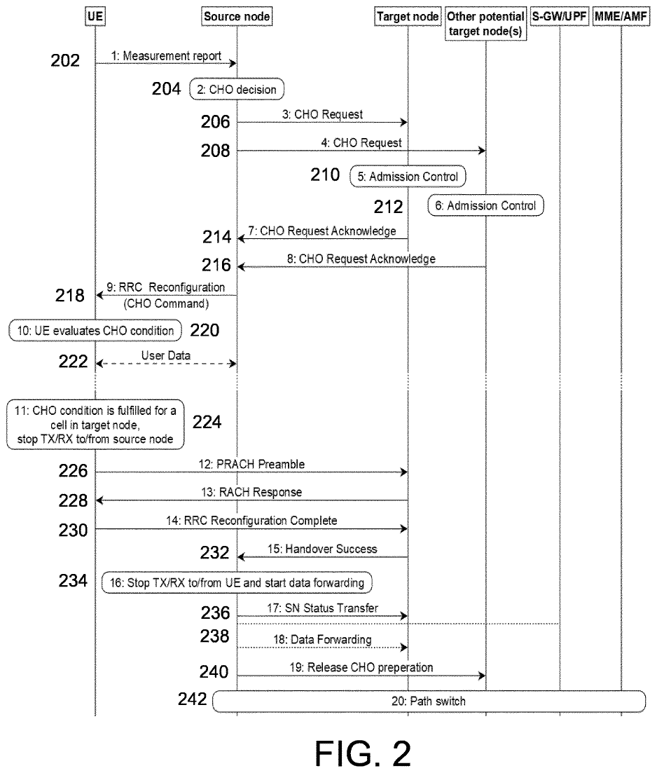

Features as described herein may generally relate to conditional handover (CHO). Referring now to FIG. 2, illustrated is an example of CHO. At 202, a UE may transmit, to a source node, a measurement report. At 204, the source node may make a CHO decision. At 206, the source node may transmit, to a target node, a CHO request. At 208, the source node may transmit, to other potential target node(s), a CHO request. At 210, the target node may perform admission control. At 212, the other potential target node(s) may perform admission control. At 214, the target node may transmit, to the source node, a CHO request acknowledgement. At 216, the other potential target node(s) may transmit, to the source node, a CHO request acknowledgement. At 218, the source node may transmit, to the UE, an RRC reconfiguration, which may include a CHO command. At 220, the UE may evaluate a CHO condition. At 222, the UE and source node may exchange user data. At 224, the UE may determine that a CHO condition is fulfilled for a cell in a target node, and may stop TX/RX to/from the source node. At 226, the UE may transmit, to the target node, a physical random access channel (PRACH) preamble. At 228, the target node may transmit, to the UE, a random access channel (RACH) response. At 230, the UE may transmit, to the target node, an RRC reconfiguration complete. At 232, the target node may transmit, to the source node, a handover success. At 234, the source node may stop TX/RX to/from the UE and start data forwarding. At 236, the source node may transmit, to the target node, a sequence number (SN) status transfer. At 238, the source node may perform data forwarding to the target node. At 240, the source node may transmit, to the target node, an indication to release CHO preparation. At 242, path switching may be performed with the source node, the target node, the other potential target node(s), S-GW/UPF, and/or MME/AMF.

The first steps 1-9 of FIG. 2 (202-218) are similar to the baseline handover of NR Rel. 15 [TS 38.300]. A configured event may trigger the UE to send a measurement report. Based on this report, the source node may prepare one or more target cells for the handover (CHO Request+CHO Request Acknowledge) and may then send an RRC Reconfiguration (CHO command) to the UE.

For baseline handover of NR Rel. 15, the UE may immediately access the target cell to complete the handover. Instead, for CHO, the UE may only access the target cell once an additional CHO execution condition expires (i.e. the HO preparation and execution phases are decoupled) (e.g. at 224). The condition may be configured by the source node in the HO command (e.g. at 218).

Once the UE completes the handover execution to the target cell (e.g. UE has sent RRC Reconfiguration Complete, e.g. at 230), the target cell may send, to the source cell, a “Handover Success” indication (e.g. at 232). When receiving this indication from the target cell, the source cell may stop its TX/RX to/from the UE and start data forwarding to the target cell, for example in step 16 (234). Moreover, the source may release the CHO preparations in other target nodes/cells (which are no longer needed) when it receives “HO Success” indication (e.g. at 240).

The advantage of the CHO is that the HO command may be sent very early, when the UE is still safe in the source cell, without risking the access in the target cell and the stability of its radio link. That is, conditional handover may provide mobility robustness.

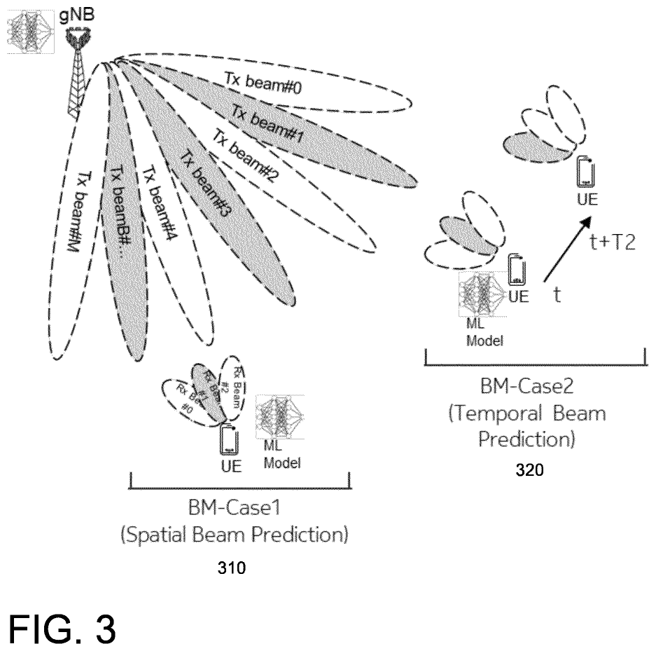

Features as described herein may generally relate to beam management. Referring now to FIG. 3, illustrated are example beam management use cases for AI/ML. In beam management case 1 (310), an example of spatial beam prediction with an ML model is illustrated. In beam management case 2 (320), an example of temporal beam prediction with an ML model is illustrated. Legacy beam management procedures (P1, P2, P3) require time-consuming operation of sweeping all the Tx and Rx beams by configuring the UE with a large number of synchronization signal blocks (SSB) and/or channel state information reference signal (CSI-RS) measurements. The Rel-18 SID on AI/ML-assisted beam management for overhead savings and latency reduction discusses BM-Case1 (spatial beam prediction) and BM-Case2 (time beam prediction). For each sub-use case, two optimization targets have the most interest: DL Tx beam prediction-P1/P2 joint optimization; and DL Tx-Rx beam pair prediction-P1/P2/P3 joint optimization. The following performance targets and KPIs are considered: beam prediction accuracy related KPIs (e.g. prediction accuracy, reference signal received power (RSRP) difference); and system performance related KPIs (e.g. UE throughput, control signal overhead, and power consumption).

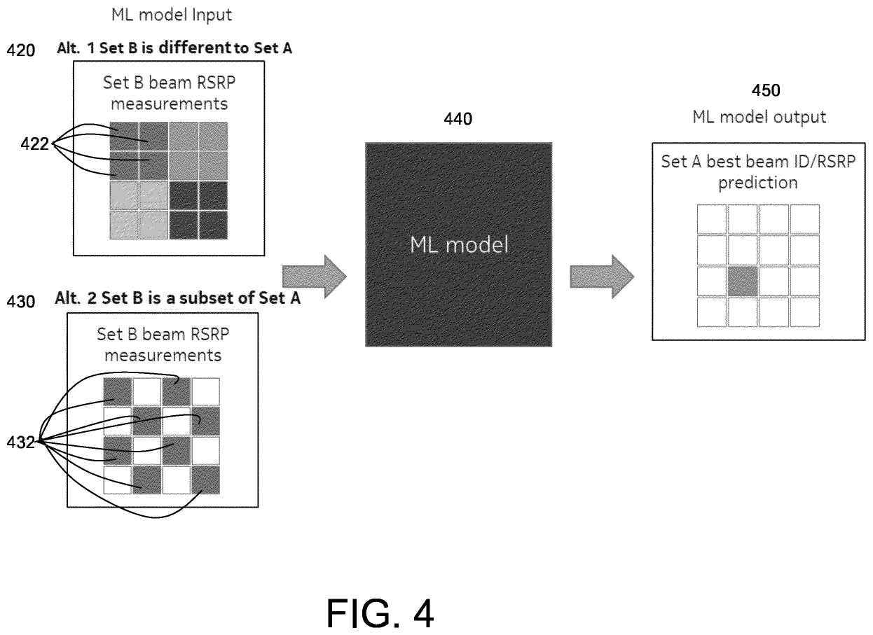

Referring now to FIG. 4, illustrated are configurations for BM-Case 1 (i.e. spatial beam prediction). Different ML model input (410) is possible for an ML model (440). In a first alternative (420) (Alt-1), set B may be different from set A. In other words, various different beam RSRP measurements may be input. Illustrated are bitmap positions on a grid for corresponding reference signals (e.g. 422). In a second alternative (430) (Alt-2), set B may be a subset of set A. The output (450) of the ML model (440) may be that set A is the best beam ID/RSRP prediction. Illustrated are bitmap positions on a grid for corresponding reference signals (e.g. 432, white boxes).

One non-limiting example of Alt-1 may allow the UE to perform a prediction of a narrow beam in Set A based on a wide beam in Set B. The same example may allow an extension with even different reference signals used, for example Set B may use SSB based beams, whereas Set A may predict CSI-RS based beams). Another non-limiting example of Alt-2 may allow predicting the Set A from Set B based on same type of reference signal (i.e., wide beam to wide beam or narrow to narrow, hence the term subset).

3GPP has discussed the following configurations for BM-Case 1 (i.e., spatial beam prediction). For the AI/ML input (410), L1-RSRP measurements may be of a subset of narrow beams, and/or of wide beams. For the AI/ML Input (410), assistance info (i.e. beam shape information, beam ID) may be input. For the AI/ML output (450), the best narrow beam ID or best narrow beam RSRP, or (internal) QoS value for beam selection may be output. An (offline) 5G system level simulator may provide model training data to the ML model (440).

It may be noted that the ML model (440) may be a UE-side ML model, network-side ML model, a one-sided ML model, or a two-sided ML model. In other words, the inference of the ML model may be performed entirely at the UE side, entirely at the network side, or partially at the UE side and partially at the network side, where ML models at each side are paired together to produce a joint inference.

While FIGS. 3-4 relate to use of AI/ML models for beam management, these examples are not limiting; AI/ML models may be used for other purposes, including but not limited to CSI feedback enhancement and positioning accuracy. Other uses of AI/ML models may be substituted where appropriate with regard to example embodiments of the present disclosure. RANI has agreed on the list of terminologies used for AI/ML in TABLE 1 below:

TABLE 1

| Terminology | Description |
|---|---|
| Data collection | A process of collecting data by the network nodes, |
| | management entity, or UE for the purpose of AI/ML |
| | model training, data analytics and inference |
| AI/ML Model | A data driven algorithm that applies AI/ML |
| | techniques to generate a set of outputs based on a set |
| | of inputs. |
| AI/ML model training | A process to train an AI/ML Model [by learning the |
| | input/output relationship] in a data driven manner and |
| | obtain the trained AI/ML Model for inference |
| AI/ML model Inference | A process of using a trained AI/ML model to produce |
| | a set of outputs based on a set of inputs |
| AI/ML model validation | A subprocess of training, to evaluate the quality of an |
| | AI/ML model using a dataset different from one used |
| | for model training, that helps selecting model |
| | parameters that generalize beyond the dataset used |
| | for model training. |
| AI/ML model testing | A subprocess of training, to evaluate the performance |
| | of a final AI/ML model using a dataset different from |
| | one used for model training and validation. |
| | Differently from AI/ML model validation, testing |
| | does not assume subsequent tuning of the model. |
| UE-side (AI/ML) model | An AI/ML Model whose inference is performed |
| | entirely at the UE |
| Network-side (AI/ML) model | An AI/ML Model whose inference is performed |
| | entirely at the network |
| One-sided (AI/ML) model | A UE-side (AI/ML) model or a Network-side |
| | (AI/ML) model |
| Two-sided (AI/ML) model | A paired AI/ML Model(s) over which joint inference |
| | is performed, where joint inference comprises AI/ML |
| | Inference whose inference is performed jointly across |
| | the UE and the network, i.e, the first part of inference |
| | is firstly performed by UE and then the remaining |
| | part is performed by gNB, or vice versa. |
| AI/ML model transfer | Delivery of an AI/ML model over the air interface, |
| | either parameters of a model structure known at the |
| | receiving end or a new model with parameters. |
| | Delivery may contain a full model or a partial model. |
| Model download | Model transfer from the network to UE |
| Model upload | Model transfer from UE to the network |
| Federated learning/ | A machine learning technique that trains an AI/ML |
| federated training | model across multiple decentralized edge nodes (e.g., |
| | UEs, gNBs) each performing local model training |
| | using local data samples. The technique requires |
| | multiple interactions of the model, but no exchange |
| | of local data samples. |
| Offline field data | The data collected from field and used for offline |
| | training of the AI/ML model |
| Online field data | The data collected from field and used for online |
| | training of the AI/ML model |
| Model monitoring | A procedure that monitors the inference performance |
| | of the AI/ML model |
| Supervised learning | A process of training a model from input and its |
| | corresponding labels. |
| Unsupervised learning | A process of training a model without labelled data. |
| Semi-supervised learning | A process of training a model with a mix of labelled |
| | data and unlabelled data |
| Reinforcement Learning (RL) | A process of training an AI/ML model from input |
| | (a.k.a. state) and a feedback signal (a.k.a. reward) |
| | resulting from the model's output (a.k.a. action) in an |
| | environment the model is interacting with. |
| Model activation | enable an AI/ML model for a specific function |
| Model deactivation | disable an AI/ML model for a specific function |
| Model switching | Deactivating a currently active AI/ML model and |
| | activating a different AI/ML model for a specific |
| | function |

U.S. Provisional Application No. 63/426,104, filed Nov. 17, 2022, is hereby incorporated by reference in its entirety. As noted in that application, from the UE perspective, during the HO procedure, a UE-side (AI/ML) model or two-sided (AI/ML) model may face different issues:

Issue 1: mismatch in ML functionality between the source and target cell(s). For example, there are functionality differences between the source and target cell ML models that need to be resolved.

Issue 2: aspect of generalization of ML functionality between the source and target cell(s). For example, how to harmonize the differences between the source and target cell ML models that need to be resolved.

Issue 3: seamless ML model operation during handover. For example, defining the necessary signaling procedures.

U.S. Provisional Application No. 63/426,104 disclosed aspects of model monitoring wherein the source gNB instructs the UE to perform a compatibility check of the ML model to be applied to a set of target cell(s). UE can report the measurements performed to the network. The source and target gNB communicate and provide a guidance using the HO command to the UE on how to manage the mobility of the ML functionality during HO. The model monitoring disclosed happens during the HO preparation phase.

However, U.S. Provisional Application No. 63/426,104 did not specifically address aspects of model functionality monitoring during the HO execution phase (i.e. the time from when the UE receives the HO command to the point in time the HO execution condition is met e.g. when event A3 (i.e., target cell signal quality (e.g., RSRP) is X dB better than the source cell) is satisfied for the configured target cell and the UE is ready to make the random access attempt to the target gNB's cell). Example embodiments of the present disclosure may relate to the HO execution phase, for example in the context of the beam prediction use case. Example embodiments of the present disclosure may relate to configuration of how and when the UE may perform model monitoring with respect to the configured target cell(s). Example embodiments of the present disclosure may relate to configuration of how and when the UE may report the model monitoring results to the network. Example embodiments of the present disclosure may relate to configuration of options the network may offer to the UE, for example that may have the technical effect of ensuring that the ML function continues reliably. Example embodiments of the present disclosure may relate to configuration of how failure conditions are dealt with. Example embodiments of the present disclosure may relate to UE adapting the model monitoring conditional to events encountered during the HO execution e.g., radio link failure, when time to trigger is running etc.

In an example embodiment, the network may provide a configuration as part of a source configuration that may contain guidance to perform ML model/functionality monitoring. The network may also provide guidance on when the UE should start triggering this procedure. One or more ML model(s)/functionality(s) may be monitored for a set of target cell(s). ML model/functionality monitoring may comprise time based monitoring or event based monitoring (e.g. based on target cell vs. source cell RSRP threshold).

In an example embodiment, the network may configure when the UE may report the results from ML model/functionality monitoring for the given set of target cell(s). UL resources (e.g. semi-persistent or configured grant based resources) may be provided for periodic reporting. The source gNB may forward the results to the target gNB. For example, when resources for the monitoring configuration need to be switched based on time, the target gNB may release the resources used for monitoring (e.g. CSI-RS resources). The network may guide the UE to progressively monitor to optimize resources (e.g., CSI-RS resources) for monitoring.

In an example embodiment, the network may guide the UE based on reported results from ML model/functionality monitoring for the given set of target cell(s). The network may configure the UE with rules to make an assessment/evaluation, during HO execution, as to which ML model/functionality to apply for a given target cell, or whether to fall back to a non-ML model.

In an example embodiment, the network may configure the UE with rules to make an assessment during HO execution as to which ML model/functionality to apply for a given target cell or, to fall back to non-ML model. The target gNB may know of which ML model/functionality the UE proposes to continue with, or indicate results from, for example, failed ML model/functionality monitoring during the HO execution phase. The network may provide a fall back configuration in case of failure.

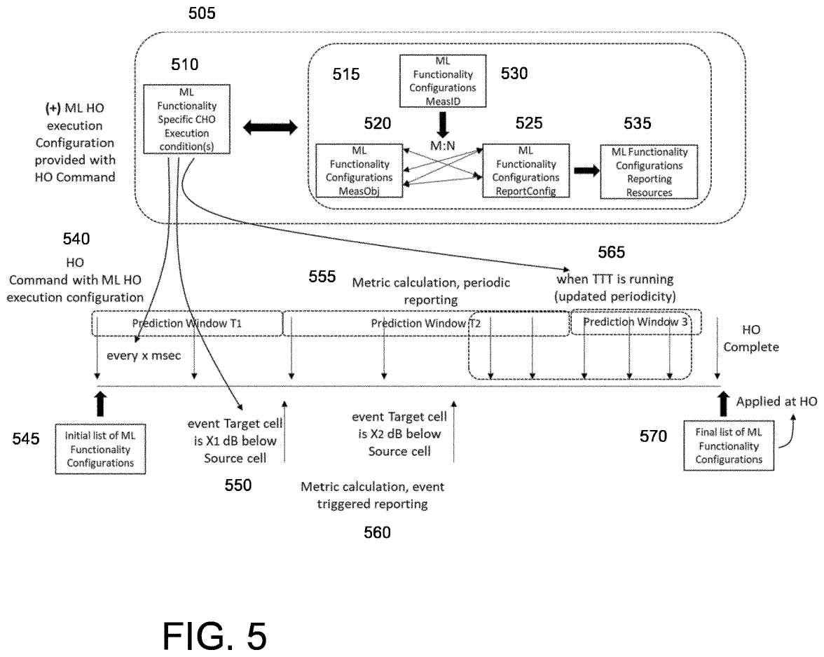

Referring now to FIG. 5, illustrated is a framework capturing an ML functionality measurement event toolbox. The ML HO execution configuration may be provided with an HO command, illustrated by dotted line box 505. The HO command (505) may include an indication of ML functionality specific CHO execution condition(s) (510). In other words, the execution conditions may be respectively linked to ML functionality configuration measurement identities. Assuming CHO as the reference HO procedure (as it is the more complicated procedure but more efficient compared to baseline handover), as part of the HO command the network may prepare the UE to perform a set of measurements on an ML enabled function. The configuration, illustrated with the dotted line box 515, may be linked to the one or more execution conditions (510) that are linked to the HO configuration. It may be noted that there may be multiple execution conditions. The configuration (515) may include ML functionality configurations MeasObj (520), which may be linked to ML functionality configurations ReportConfig (525). These pairs are linked together using ML functionality configurations MeasID (530). The ML functionality configurations ReportConfig (525) may be linked to ML functionality Configurations Reporting Resources (535) that allow reporting of the results from the measurements made on the ML functionality configurations MeasID (530).

Each ID may allow assessment of one or more ML functionality configuration combinations linked to one or more assessment reporting configurations. Reporting may be enabled by additionally configuring reporting resources.

The UE may receive an HO command with ML HO execution configuration (540). The UE may start with an initial list of ML functionality configurations that need an assessment during the HO execution phase (545). In the example of FIG. 5, both beam prediction in the spatial domain and beam prediction in the time domain are being considered to illustrate the point that multiple ML enabled functionalities may be assessed during the HO execution phase. The measurements performed by the UE on the initial list of ML functionality configurations may be performed based on a repetition pattern or based on an event. These may be adapted by the UE depending on the outcome of the intermediate measurements. For example, the UE may adapt the prediction window of the time domain beam prediction if the assessment for the larger window falls below a reference quality threshold; the UE may increase the frequency of the assessment when the time to trigger (TTT) timer is running or when the source radio link is under radio link failure (RLF), etc.

In other words, the UE may be able to adapt the prediction window and periodicity of the assessment based on target metrics as well as during specific occasions (e.g. TTT, T312 expiry, etc.).

An event may occur in which the target cell is X1 dB below the source cell (550); this may fulfill a CHO execution condition. Depending on the reporting options, the intermediate results of the ML functionality evaluation may be reported to the network. Metric calculation and periodic reporting may be performed (555). An event may occur in which the target cell is X2 dB below the source cell. Metric calculation and event triggered reporting may occur (560). When TTT is running, updates may be transmitted periodically with an adapted frequency of the updates compared to normal periodical reporting (565).

As the UE filters the functionality configuration list during the HO execution phase, it may determine a final list of ML functionality configurations for the target cell that may be applied reliably during the HO complete phase (i.e. at the time of random access to the target cell, for example so that the ML functionality may proceed smoothly in the target cell). When the UE has determined the final list of ML functionality configuration (570), such ML functionality configurations may be applied at HO.

It may be noted that, to support this assessment, the UE may need improved capabilities (e.g. ability to instantiate ML model for a given use case/functionality for one or more target cells, how many maximum measurement identities UE can support for such ML functionality assessment, support of periodic or event triggered measurements, support of multiple execution conditions, support for adaptive prediction window, support of set of KPI for metric of evaluation, ability to support multiple use case or prioritize, support of collecting data samples to perform the model monitoring, support of labelling data samples during model monitoring and updating the results to the network, etc.).

In an example embodiment, the initial list of functionality configurations for the ML may be explored by the UE and the final list of functionality configurations may be the one(s) which have been able to survive during the HO execution phase and may be selected by the UE to switch to during the target cell activation. In an example, the initial list may contain M configurations, while the final list may only contain N configurations (N e.g., 3<<M e.g., 10). The initial list may be pruned/reduced as a result of the monitoring during the HO execution phase; the N configurations may “survive”, as not all the configurations may manage to survive the model monitoring.

In an example embodiment, a configuration included with the HO command may prepare the UE to perform a set of measurements on an ML enabled function. The configuration may be linked to one or more execution conditions that are linked to the HO configuration. The UE may start with an initial list of ML functionality configurations that may need an assessment during the HO execution phase. The measurements performed by the UE on the initial list of ML functionality configurations may be performed based on a repetition pattern, or based on an event. The measurements my be adapted by the UE depending on the outcome of intermediate measurements. For example, the UE may adapt the prediction window of the time domain beam prediction if the assessment for a larger window falls below a reference quality threshold. For example, the UE may increase the frequency of the assessment when the TTT timer is running, or when the source radio link is under RLF, etc. As the UE filters the functionality configuration list during the HO execution phase, it may generate a final list of ML functionality configurations for the target cell that may be applied reliably during the HO complete phase (i.e. at the time of random access to the target cell) so that the ML functionality may proceed smoothly in the target cell. Depending on the reporting options, the intermediate results of the ML functionality evaluation may be reported to the network.

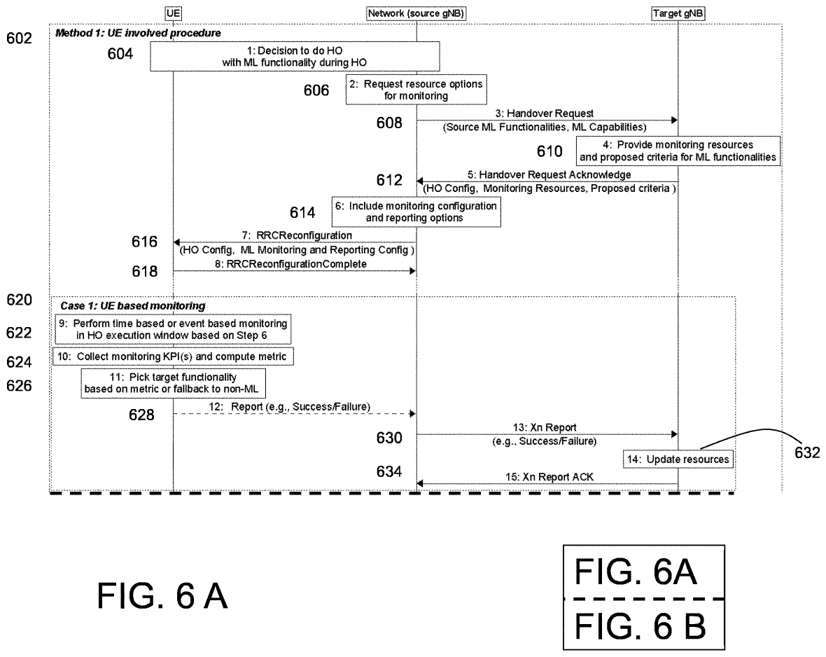

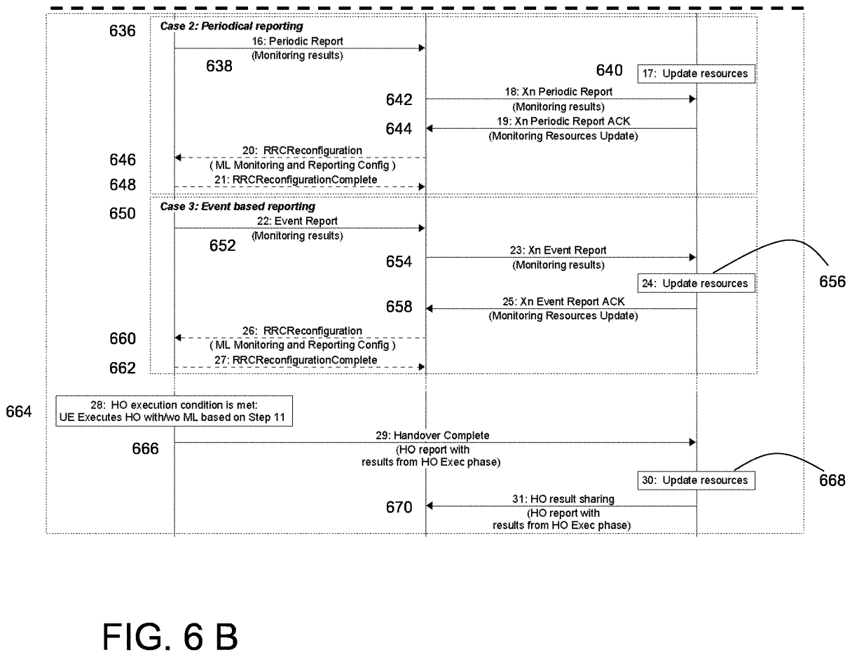

Referring now to FIG. 6A and FIG. 6B, illustrated is a flow chart showing various cases according to an example of a UE involved procedure (602) of the present disclosure. As a pre-condition, it may be assumed that there is a beam prediction ML functionality enabled for the UE in the cell controlled by the source gNB, and that there is a decision to make HO to a target cell in the target gNB. It may be noted that more than one target cell candidate may also be prepared for one or more target gNB(s); the example of FIG. 6A and FIG. 6B is not limiting. At 604, the UE and the network (e.g. source gNB) may decide to perform HO with ML functionality during HO.

At 606, the network may format a request for resource options for monitoring. At 608, the network may transmit, to the target gNB, a handover request. The handover request may include (indications of) source ML functionalities and/or ML capabilities. The source gNB may request resources to the target gNB for not only the HO related configuration, but also for commanding the UE to perform beam prediction monitoring the target cell. To enable this, the source gNB may provide the source ML functionalities configured for the beam prediction, as well as the ML capabilities for the UE corresponding to beam prediction (the capabilities may usually be indicated in the form of functionality combinations that the UE supports so that the target cell may determine if the same functionality as the source, or a different functionality combination, should be used). For example, a functionality difference may be a prediction window length difference, differences in the Set B dimension (e.g. a grid of 8×8 beams vs. 16×8), difference in the number of predicted beams i.e., top K (K=2, 4, 8) and so on. Each functionality combination may require a separate set of monitoring resources.

At 610, the target gNB may provide monitoring resources and proposed criteria for ML functionalities. At 612, the target gNB may transmit, to the network, a handover request acknowledgement. The HO ACK may include an HO configuration, monitoring resources, proposed criteria, etc. The target gNB may provide monitoring resources in accordance with the functionality it wishes to select for the given UE, and may return the monitoring resources and functionality combinations configuration. There are several options here that the target base station may provide.

In an example embodiment, beam prediction may be performed in the spatial domain. A target gNB may set one or more execution conditions, which may be referenced in a list. Each of the execution conditions may be signaled. A few examples of execution conditions may be absolute RSRP threshold levels for target cell (i.e. UE may be required to assess the functionality combinations described below every time a target cell RSRP threshold cross a given dBm value, for example −90 dBm), event threshold levels (e.g. difference between target and source cell may be −3, −2, −1 dB), etc. These execution conditions may have further refined criteria, for example: monitor functionality combination x, y, z when time to trigger TTT is started; stop monitoring a, b, c functionality combination when the source cell radio link quality drops below a given threshold; etc.

It may be noted that, for each execution condition, a list of which functionality combinations to monitor may be attached. Accordingly, it may so happen that the UE may have to monitor multiple functionality combinations for a beam prediction in the time and spatial domain at same time. However, this may be a matter of UE capability.

A target gNB may want the UE to monitor two separate functionality combinations, for example Combination 1 and Combination 2, where:
Combination 1: 16×16 grid of SSB beams of Set B, 512 msec prediction window, output is Set A of 16×16 SSB beams; and
Combination 2: 32×32 grid of CSI-RS beams with of Set B, 256 msec prediction window, output is Set A of 16×16 SSB beams.

The network may determine these functionality combinations based on the support of the ML assisted feature in the target cell, and also based on what functionality combinations may be configured for the UE determined by the applicability conditions. For example, for Combination 1, the UE may be capable of Top K beams=8, 4, 2, 1, but for Combination 2, it may be capable only of Top K beams=4, 2, 1.

For each of these combinations, it may be noted that a separate monitoring configuration may be required, as well as a proposed metric (e.g. prediction accuracy with a recommended value).

In addition, a monitoring event may be proposed which may be a duration of time (e.g., every 20 msec until HO execution criteria) or based on a measurement event in the UE (i.e. every time source cell has become worse than the target cell by 1 dB).

With multiple such monitoring configurations, there may be a threshold provided to guide the UE to apply the correct one at HO execution. For example, the UE may be provided with a threshold of at least at least 70% for Combination 1, and a threshold of at least 90% for Combination 2, and a rule that chooses the better. If the UE finds prediction accuracy 90% or greater for Combination 2, and greater than 70% for Combination 1, then it may choose Combination 2. If the UE finds prediction accuracy greater than 70% for combination 2 and roughly 80% for Combination 1, then the UE may choose Combination 1.

The combining rules for the proposed metric (e.g. rules for determining the sample size input to the metric, the way the input samples may be combined to produce the proposed metric, etc.) may be provided for the UE. For example, for the time duration case, a linear average combining rule may be provided. For example, for the event based case, an average over last N samples collected or latest sample combining rule may be provided. For example, a linear average of RSRP(s) or a weighted average of RSRP(s) in which the weights to be use may be provided by the network.

In an example embodiment, beam prediction may be performed in the time domain. A target gNB may want the UE to monitor two separate functionality combinations, for example Combination 1 and Combination 2, where:
Combination 1: Top K beams=4 for a maximum prediction interval of 500 msec; and
Combination 2: Top K beams=8 for a maximum prediction interval of 200 msec.

For each of these combinations, it may be noted that a separate monitoring configuration may be required, as well as a proposed metric (e.g. prediction accuracy with a recommended value).

The UE may be configured to scale the prediction window within each configuration, or attempt to scale the prediction windows, based on the HO execution condition.

The examples of beam prediction in the spatial domain and beam prediction in the time domain may be executed by the UE in parallel, or may be instructed by the network to follow some other pattern for a given cell. For example, some UE may perform beam prediction in the time domain for some cell(s), and perform spatial domain beam prediction for other cell(s). Other combinations may not be precluded (e.g. time window dedicated for each case).

Referring now to FIG. 6A and FIG. 6B, at 614, the network may include the monitoring configuration and reporting options. The source gNB may use the monitoring resources and functionality combination options provided by the target gNB, and may decide to override some of the criteria if required. For example, the thresholds described at 610, 612 may be updated to lower ones, or the rule to choose (e.g. adaptation of target gNB suggestion) may be adjusted if the source gNB thinks it is too aggressive for the UE.

At 616, the network may transmit, to the UE, an RRCReconfiguration, which may include the HO configuration and/or a ML monitoring and reporting configuration. For example, the network may provide a configuration, as part of a source configuration, containing guidance to perform ML model/functionality monitoring. The source gNB may also attach the “monitoring resource” identities to the RRC configuration and link the different options for the UE to report the results. For example, UL resources (e.g. semi-persistent or configured grant based resources) may be provided for periodic reporting. The network may also provide guidance on when a UE should start triggering the ML model/functionality monitoring. The network may also configure when the UE may report the results from the ML model/functionality monitoring. The network may also provide a fallback configuration in case of failure of all the functionality combinations. The UE may receive the RRC reconfiguration and, at 618, may acknowledge the message; for example, the UE may transmit, to the network, an RRCReconfigurationComplete.

At 620, case 1: UE based monitoring may be performed. At 622, the UE may perform time based or event based monitoring in the HO execution window based on, for example, the monitoring configuration. The UE may process the configuration and start the measurements on the given functionality combinations for the given target cell. At 624, the UE may collect monitoring KPI(s) and compute metric. The UE may be configured to perform event based monitoring (e.g. based on a target cell vs source cell RSRP threshold). Additionally or alternatively, the UE may be configured to perform time based monitoring. At 628, the UE may, optionally, report the results of these measurements (e.g. success/failure) to the network using the resources provided at 616 for the reporting.

At 626, the UE may pick a target functionality based on the metric, or fall back to non-ML functionality. Closer to the HO execution condition (e.g. an instant of time when the last 20 msec of the TTT is going to expire) the UE may have determined which functionality combination it will pick, finally, at the HO execution. If no single functionality combination is found to be valid (e.g. all target functionalities are found to be invalid or are excluded), the UE may revert back to a non-ML configuration. This default configuration may be indicated in the HO configuration.

At 628, the UE may send a report, which may or may not be received by the source gNB, for example due to poor radio quality. The UE may send the report very close to HO execution, assuming the source gNB radio quality is adequate enough to send it and the UE is not already seeing source link close to failure. The UE may store the report, in case it was unable to send it, to be sent later at the HO complete message transmission at 666. The report may indicate the overall metric and decision of the checks the UE made for the different functionality combinations and may also comprise data samples that were collected/used for the different functionality combinations. At 630, the source gNB may forward the result to the target gNB. At 632, the target gNB may release the resources for all the functionality combinations that were not chosen by the UE. At 634, the target gNB may transmit, to the network, an Xn report ACK.

At 636, case 2: periodic reporting may be performed. At 638, the UE may transmit, to the network, a periodic report including the results of the monitoring on the functionality combinations and may also comprise data samples that were collected/used for the different functionality combinations. The periodic report may be based on the configuration provided by the network. The report may include measurements on the given functionality combinations for the given target cell. The report may be transmitted using the reporting configuration resources provided. At 642, the network may forward the periodic report to the target gNB. At 640, the target gNB may update the resources. Additionally or alternatively, the target gNB may choose to update the resources according to the periodic report.

For example, if the metric measured for functionality combination 1 already seems too low (e.g. 30% over few samples) then the source gNB may propose that the target gNB drop functionality combination 1. Corresponding to this request, the target gNB may release the resources for the poorly performing functionality combinations. In other words, the target gNB may determine that the UE will not select a functionality combination based on the metric.

At 644, the target gNB may transmit, to the network, an Xn periodic report ACK, which may include a monitoring resources update.

The source gNB may update the monitoring resources corresponding to the different functionality combinations to the UE, or provide additional functionality combinations that are updated since the earlier configuration that was provided at 616. At 646, the network may, optionally, transmit an RRCReconfiguration to the UE. The RRCReconfiguration may include an ML monitoring and reporting configuration. In other words, the network may provide guidance to the UE based on reported results of the ML model/functionality monitoring. At 648 the UE may, optionally, transmit an RRCReconfigurationComplete to the network. These steps are optional because the reconfiguration messages may not be sent if there is no need (e.g. no failing functionality configurations).

At 650, case 3: event based reporting may be performed. Based on the configuration provided by the network, at 652, the UE may transmit, to the network, an event report, which may comprise the monitoring results and may also comprise data samples that were collected/used for the different functionality combinations. The UE may transmit the report based on an event which caused the reporting (e.g. the target cell is −3 dB lower than the source cell, or when the target cell is −2 dB lower than the source cell, or when the target cell crosses a threshold of X dBm, the reporting configuration resources provide the results of the monitoring on the functionality combinations). At 654, the network may forward the event report to the target gNB in an Xn event report. At 656, the target gNB may update the resources accordingly. For example, if the metric measured for functionality combination 1 already seems too low (e.g. 30% over few samples), then the source gNB may propose to the target gNB to drop this functionality combination. Corresponding to this request, the target gNB may release the resources for the poorly performing functionality combination(s). In other words, the target gNB may determine that the UE will not select a functionality combination based on the metric. At 658, the target gNB may transmit, to the network, an Xn event report ACK, which may include a monitoring resources update.

The source gNB may update the monitoring resources corresponding to the different functionality combinations provided, or provide additional functionality combinations that have been updated since the earlier configuration was provided at 616. At 660, the network may, optionally, transmit an RRCReconfiguration to the UE. The RRCReconfiguration may include an ML monitoring and reporting configuration. In other words, the network may provide guidance to the UE based on reported results of the ML model/functionality monitoring. At 662, the UE may, optionally, transmit an RRCReconfigurationComplete to the network. These steps are optional because the reconfiguration messages may not be sent if there is no need (e.g. no failing functionality configurations).

Whether case 1 (620), case 2 (636), or case 3 (650) is performed, when the HO execution condition is reached, the UE may be armed/prepared to execute the handover with ML functionality in a reliable manner, or not. As it may make a decision on which functionality combination to choose, or revert to non-ML operation, this may have the technical effect of avoiding the issue of uncertain performance during the HO. At 664, the UE may determine that the HO execution condition has been met. The UE may execute HO with or without ML functionality based on selected target functionality or fallback position. At 666, the UE may send the results from the HO, to the target gNB in the complete message, of the instantaneous metric on the chosen functionality combination (if selected). The results may indicate the overall metric and decision of the checks the UE made for the different functionality combinations and may also comprise data samples that were collected/used for the different functionality combinations. This may allow both the source and target gNBs to know the final choice of the UE and the overall metric of performance (as the UE may not have been able to report the metric due to poor UL quality of source gNB). At 668, the target gNB may release the resources corresponding to the monitoring resources, as these are no longer required. At 670, the target gNB may transmit, to the source gNB, HO result sharing, which may include the HO report with results from HO execution phase received from the UE.

A technical effect of example embodiments of the present disclosure may be to allow definition of UE behavior and further allow the network to provide different options to the UE to recovery from failure scenarios.

A technical effect of example embodiments of the present disclosure may be to enable the network to guarantee clear interoperable behavior of the UE supporting ML model/functionality during the HO execution phase, and avoid failure in HO due to poor ML functionality operation.

A technical effect of example embodiments of the present disclosure may be to allow the network to determine which ML model/functionality did not perform well during the HO execution phase to guide further ML functionality configuration for other UE(s).

A technical effect of example embodiments of the present disclosure may be to improve the reliability of ML functionality operation and handling during HO execution phase (which happens outside network influence), under the control of a network configuration avoiding uncertain/bad performance of UE during HO.

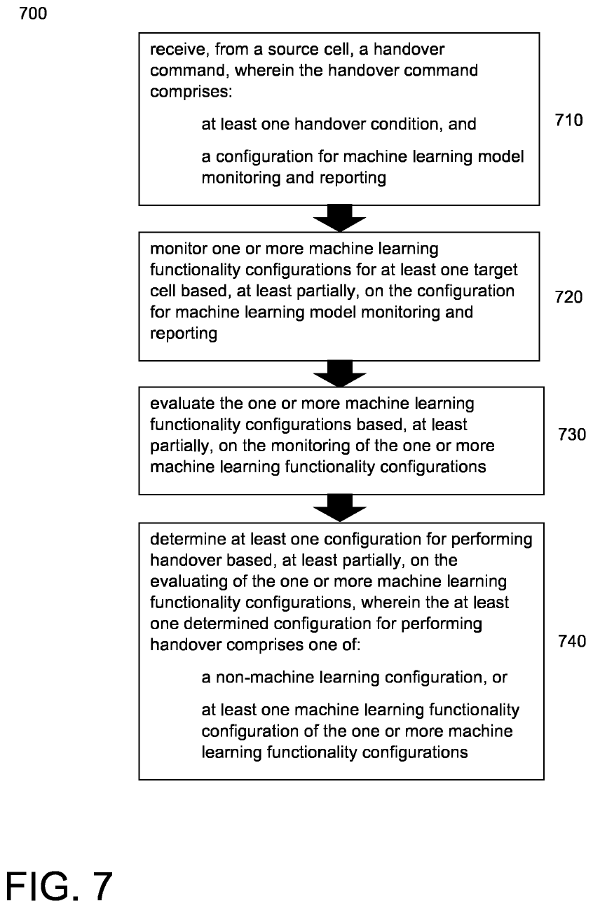

FIG. 7 illustrates the potential steps of an example method 700. The example method 700 may include: receiving, from a source cell, a handover command, wherein the handover command comprises: at least one handover condition, and a configuration for machine learning model monitoring and reporting, 710; monitoring one or more machine learning functionality configurations for at least one target cell based, at least partially, on the configuration for machine learning model monitoring and reporting, 720; evaluating the one or more machine learning functionality configurations based, at least partially, on the monitoring of the one or more machine learning functionality configurations, 730; and determining at least one configuration for performing handover based, at least partially, on the evaluating of the one or more machine learning functionality configurations, wherein the at least one determined configuration for performing handover comprises one of: a non-machine learning configuration, or at least one machine learning functionality configuration of the one or more machine learning functionality configurations, 740. The example method 700 may be performed, for example, with a user equipment.

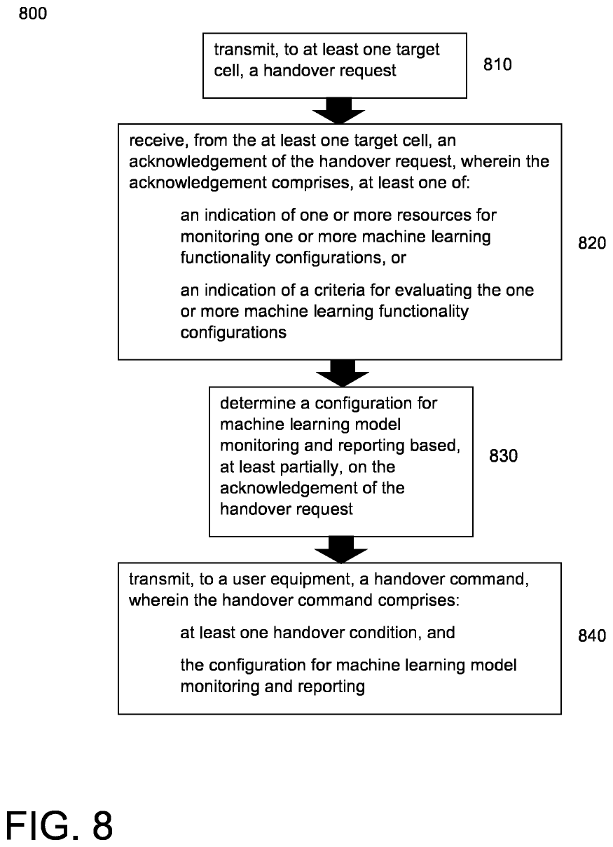

FIG. 8 illustrates the potential steps of an example method 800. The example method 800 may include: transmitting, to at least one target cell, a handover request, 810; receiving, from the at least one target cell, an acknowledgement of the handover request, wherein the acknowledgement comprises, at least one of: an indication of one or more resources for monitoring one or more machine learning functionality configurations, or an indication of a criteria for evaluating the one or more machine learning functionality configurations, 820; determining a configuration for machine learning model monitoring and reporting based, at least partially, on the acknowledgement of the handover request, 830; and transmitting, to a user equipment, a handover command, wherein the handover command comprises: at least one handover condition, and the configuration for machine learning model monitoring and reporting, 840. The example method 800 may be performed, for example, with a source cell, base station, gNB, network node, etc.

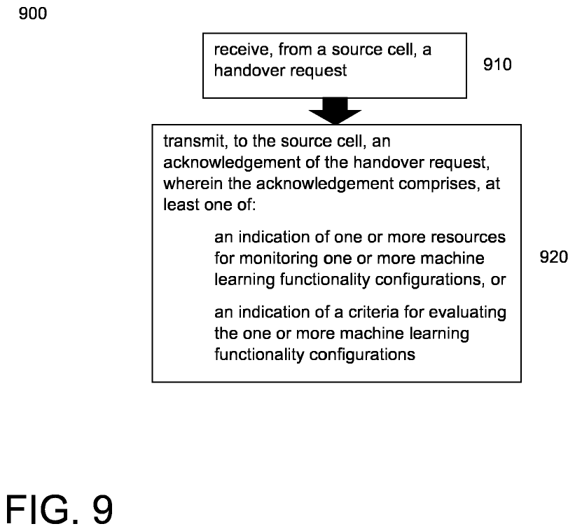

FIG. 9 illustrates the potential steps of an example method 900. The example method 900 may include: receiving, from a source cell, a handover request, 910; and transmitting, to the source cell, an acknowledgement of the handover request, wherein the acknowledgement comprises, at least one of: an indication of one or more resources for monitoring one or more machine learning functionality configurations, or an indication of a criteria for evaluating the one or more machine learning functionality configurations, 920. The example method 900 may be performed, for example, with at target cell, base station, gNB, network node, etc.

In accordance with one example embodiment, an apparatus may comprise: at least one processor; and at least one memory storing instructions that, when executed by the at least one processor, cause the apparatus at least to: receive, from a source cell, a handover command, wherein the handover command may comprise: at least one handover condition, and a configuration for machine learning model monitoring and reporting; monitor one or more machine learning functionality configurations for at least one target cell based, at least partially, on the configuration for machine learning model monitoring and reporting; evaluate the one or more machine learning functionality configurations based, at least partially, on the monitoring of the one or more machine learning functionality configurations; and determine at least one configuration for performing handover based, at least partially, on the evaluating of the one or more machine learning functionality configurations, wherein the at least one determined configuration for performing handover may comprise one of: a non-machine learning configuration, or at least one machine learning functionality configuration of the one or more machine learning functionality configurations.

The configuration for machine learning model monitoring and reporting may comprise at least one of: an indication of a trigger condition for performing monitoring, an indication of when to perform monitoring, an indication of a metric for the evaluating, an indication of a threshold for the evaluating, an indication of when to report results of the evaluating, or an indication of at least one resource for reporting the results of the evaluating.

The indication of when to report the results of the evaluating may comprise at least one of: an indication of repetition pattern for reporting the results of the evaluating, or an indication of an event configured to trigger reporting the results of the evaluating.

The indication of when to report the results of the evaluating may comprise an indication of a threshold value for a comparison of a reference signal received power of the at least one target cell with a reference signal received power of the source cell.

The configuration for machine learning model monitoring and reporting may comprise an indication of the non-machine learning configuration.

The example apparatus may be further configured to: receive, from the source cell, at least one reconfiguration, wherein the monitoring of the one or more machine learning functionality configurations may be further based on the at least one reconfiguration.

The example apparatus may be further configured to: adapt the monitoring of the one or more machine learning functionality configurations based, at least partially, on at least one intermediate result of the monitoring.

Adapting the monitoring may comprise the example apparatus being further configured to at least one of: adapt a time window for the monitoring of the one or more machine learning functionality configurations; or adapt a frequency for the monitoring of the one or more machine learning functionality configurations.

The at least one configuration for performing handover may be determined to be the non-machine learning configuration based, at least partially, on the evaluating of the one or more machine learning functionality configurations resulting in a determination that the one or more machine learning functionality configurations are not valid for the at least one target cell.

The at least one handover condition may be associated with the one or more machine learning functionality configurations, wherein the configuration for machine learning model monitoring and reporting may be associated with the one or more machine learning functionality configurations.

The example apparatus may be further configured to: determine that the at least one handover condition has been met; and in response to the determination that the at least one handover condition has been met, perform handover to the at least one target cell using the determined configuration.

The example apparatus may be further configured to: transmit, to the source cell, at least one result of the evaluating of the one or more machine learning functionality configurations.

The at least one result may comprise at least one of: an intermediate result, or a final result.

The at least one result may be transmitted periodically.

The at least one result may be transmitted in response to an event.

The example apparatus may be further configured to: transmit, to the source cell, at least one of: an indication of the at least one determined configuration for performing handover, an evaluation for respective ones of the one or more machine learning functionality configurations, or an indication of at least one of the one or more machine learning functionality configurations that is not to be used for handover.

In accordance with one aspect, an example method may be provided comprising: receiving, with a user equipment from a source cell, a handover command, wherein the handover command may comprise: at least one handover condition, and a configuration for machine learning model monitoring and reporting; monitoring one or more machine learning functionality configurations for at least one target cell based, at least partially, on the configuration for machine learning model monitoring and reporting; evaluating the one or more machine learning functionality configurations based, at least partially, on the monitoring of the one or more machine learning functionality configurations; and determining at least one configuration for performing handover based, at least partially, on the evaluating of the one or more machine learning functionality configurations, wherein the at least one determined configuration for performing handover may comprise one of: a non-machine learning configuration, or at least one machine learning functionality configuration of the one or more machine learning functionality configurations.

The configuration for machine learning model monitoring and reporting may comprise at least one of: an indication of a trigger condition for performing monitoring, an indication of when to perform monitoring, an indication of a metric for the evaluating, an indication of a threshold for the evaluating, an indication of when to report results of the evaluating, or an indication of at least one resource for reporting the results of the evaluating.

The indication of when to report the results of the evaluating may comprise at least one of: an indication of repetition pattern for reporting the results of the evaluating, or an indication of an event configured to trigger reporting the results of the evaluating.

The indication of when to report the results of the evaluating may comprise an indication of a threshold value for a comparison of a reference signal received power of the at least one target cell with a reference signal received power of the source cell.

The configuration for machine learning model monitoring and reporting may comprise an indication of the non-machine learning configuration.

The example method may further comprise: receiving, from the source cell, at least one reconfiguration, wherein the monitoring of the one or more machine learning functionality configurations may be further based on the at least one reconfiguration.

The example method may further comprise: adapting the monitoring of the one or more machine learning functionality configurations based, at least partially, on at least one intermediate result of the monitoring.

The adapting of the monitoring may comprise at least one of: adapting a time window for the monitoring of the one or more machine learning functionality configurations; or adapting a frequency for the monitoring of the one or more machine learning functionality configurations.

The at least one configuration for performing handover may be determined to be the non-machine learning configuration based, at least partially, on the evaluating of the one or more machine learning functionality configurations resulting in a determination that the one or more machine learning functionality configurations are not valid for the at least one target cell.

The at least one handover condition may be associated with the one or more machine learning functionality configurations, wherein the configuration for machine learning model monitoring and reporting may be associated with the one or more machine learning functionality configurations.

The example method may further comprise: determining that the at least one handover condition has been met; and in response to the determination that the at least one handover condition has been met, performing handover to the at least one target cell using the determined configuration.

The example method may further comprise: transmitting, to the source cell, at least one result of the evaluating of the one or more machine learning functionality configurations.

The at least one result may comprise at least one of: an intermediate result, or a final result.

The at least one result may be transmitted periodically.

The at least one result may be transmitted in response to an event.

The example method may further comprise: transmitting, to the source cell, at least one of: an indication of the at least one determined configuration for performing handover, an evaluation for respective ones of the one or more machine learning functionality configurations, or an indication of at least one of the one or more machine learning functionality configurations that is not to be used for handover.

In accordance with one example embodiment, an apparatus may comprise: circuitry configured to perform: receiving, from a source cell, a handover command, wherein the handover command may comprise: at least one handover condition, and a configuration for machine learning model monitoring and reporting; circuitry configured to perform: monitoring one or more machine learning functionality configurations for at least one target cell based, at least partially, on the configuration for machine learning model monitoring and reporting; circuitry configured to perform: evaluating the one or more machine learning functionality configurations based, at least partially, on the monitoring of the one or more machine learning functionality configurations; and circuitry configured to perform: determining at least one configuration for performing handover based, at least partially, on the evaluating of the one or more machine learning functionality configurations, wherein the at least one determined configuration for performing handover may comprise one of: a non-machine learning configuration, or at least one machine learning functionality configuration of the one or more machine learning functionality configurations.

In accordance with one example embodiment, an apparatus may comprise: processing circuitry; memory circuitry including computer program code, the memory circuitry and the computer program code configured to, with the processing circuitry, enable the apparatus to: receive, from a source cell, a handover command, wherein the handover command may comprise: at least one handover condition, and a configuration for machine learning model monitoring and reporting; monitor one or more machine learning functionality configurations for at least one target cell based, at least partially, on the configuration for machine learning model monitoring and reporting; evaluate the one or more machine learning functionality configurations based, at least partially, on the monitoring of the one or more machine learning functionality configurations; and determine at least one configuration for performing handover based, at least partially, on the evaluating of the one or more machine learning functionality configurations, wherein the at least one determined configuration for performing handover may comprise one of: a non-machine learning configuration, or at least one machine learning functionality configuration of the one or more machine learning functionality configurations.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for: receiving, from a source cell, a handover command, wherein the handover command may comprise: at least one handover condition, and a configuration for machine learning model monitoring and reporting; monitoring one or more machine learning functionality configurations for at least one target cell based, at least partially, on the configuration for machine learning model monitoring and reporting; evaluating the one or more machine learning functionality configurations based, at least partially, on the monitoring of the one or more machine learning functionality configurations; and determining at least one configuration for performing handover based, at least partially, on the evaluating of the one or more machine learning functionality configurations, wherein the at least one determined configuration for performing handover may comprise one of: a non-machine learning configuration, or at least one machine learning functionality configuration of the one or more machine learning functionality configurations.

The configuration for machine learning model monitoring and reporting may comprise at least one of: an indication of a trigger condition for performing monitoring, an indication of when to perform monitoring, an indication of a metric for the evaluating, an indication of a threshold for the evaluating, an indication of when to report results of the evaluating, or an indication of at least one resource for reporting the results of the evaluating.

The indication of when to report the results of the evaluating may comprise at least one of: an indication of repetition pattern for reporting the results of the evaluating, or an indication of an event configured to trigger reporting the results of the evaluating.

The indication of when to report the results of the evaluating may comprise an indication of a threshold value for a comparison of a reference signal received power of the at least one target cell with a reference signal received power of the source cell.

The configuration for machine learning model monitoring and reporting may comprise an indication of the non-machine learning configuration.

The means may be further configured for: receiving, from the source cell, at least one reconfiguration, wherein the monitoring of the one or more machine learning functionality configurations may be further based on the at least one reconfiguration.

The means may be further configured for: adapting the monitoring of the one or more machine learning functionality configurations based, at least partially, on at least one intermediate result of the monitoring.

The means configured for adapting the monitoring may comprise means configured for at least one of: adapting a time window for the monitoring of the one or more machine learning functionality configurations; or adapting a frequency for the monitoring of the one or more machine learning functionality configurations.

The at least one configuration for performing handover may be determined to be the non-machine learning configuration based, at least partially, on the evaluating of the one or more machine learning functionality configurations resulting in a determination that the one or more machine learning functionality configurations are not valid for the at least one target cell.

The at least one handover condition may be associated with the one or more machine learning functionality configurations, wherein the configuration for machine learning model monitoring and reporting may be associated with the one or more machine learning functionality configurations.

The means may be further configured for: determining that the at least one handover condition has been met; and in response to the determination that the at least one handover condition has been met, performing handover to the at least one target cell using the determined configuration.

The means may be further configured for: transmitting, to the source cell, at least one result of the evaluating of the one or more machine learning functionality configurations.

The at least one result may comprise at least one of: an intermediate result, or a final result.

The at least one result may be transmitted periodically.

The at least one result may be transmitted in response to an event.

The means may be further configured for: transmitting, to the source cell, at least one of: an indication of the at least one determined configuration for performing handover, an evaluation for respective ones of the one or more machine learning functionality configurations, or an indication of at least one of the one or more machine learning functionality configurations that is not to be used for handover.

A processor, memory, and/or example algorithms (which may be encoded as instructions, program, or code) may be provided as example means for providing or causing performance of operation.

In accordance with one example embodiment, a non-transitory computer-readable medium comprising instructions stored thereon which, when executed with at least one processor, cause the at least one processor to: cause receiving, from a source cell, of a handover command, wherein the handover command may comprise: at least one handover condition, and a configuration for machine learning model monitoring and reporting; monitor one or more machine learning functionality configurations for at least one target cell based, at least partially, on the configuration for machine learning model monitoring and reporting; evaluate the one or more machine learning functionality configurations based, at least partially, on the monitoring of the one or more machine learning functionality configurations; and determine at least one configuration for performing handover based, at least partially, on the evaluating of the one or more machine learning functionality configurations, wherein the at least one determined configuration for performing handover may comprise one of: a non-machine learning configuration, or at least one machine learning functionality configuration of the one or more machine learning functionality configurations.

In accordance with one example embodiment, a non-transitory computer-readable medium comprising program instructions stored thereon for performing at least the following: causing receiving, from a source cell, of a handover command, wherein the handover command may comprise: at least one handover condition, and a configuration for machine learning model monitoring and reporting; monitoring one or more machine learning functionality configurations for at least one target cell based, at least partially, on the configuration for machine learning model monitoring and reporting; evaluating the one or more machine learning functionality configurations based, at least partially, on the monitoring of the one or more machine learning functionality configurations; and determining at least one configuration for performing handover based, at least partially, on the evaluating of the one or more machine learning functionality configurations, wherein the at least one determined configuration for performing handover may comprise one of: a non-machine learning configuration, or at least one machine learning functionality configuration of the one or more machine learning functionality configurations.

In accordance with another example embodiment, a non-transitory program storage device readable by a machine may be provided, tangibly embodying instructions executable by the machine for performing operations, the operations comprising: causing receiving, from a source cell, of a handover command, wherein the handover command may comprise: at least one handover condition, and a configuration for machine learning model monitoring and reporting; monitoring one or more machine learning functionality configurations for at least one target cell based, at least partially, on the configuration for machine learning model monitoring and reporting; evaluating the one or more machine learning functionality configurations based, at least partially, on the monitoring of the one or more machine learning functionality configurations; and determining at least one configuration for performing handover based, at least partially, on the evaluating of the one or more machine learning functionality configurations, wherein the at least one determined configuration for performing handover may comprise one of: a non-machine learning configuration, or at least one machine learning functionality configuration of the one or more machine learning functionality configurations.

In accordance with another example embodiment, a non-transitory computer-readable medium comprising instructions that, when executed by an apparatus, cause the apparatus to perform at least the following: causing receiving, from a source cell, of a handover command, wherein the handover command may comprise: at least one handover condition, and a configuration for machine learning model monitoring and reporting; monitoring one or more machine learning functionality configurations for at least one target cell based, at least partially, on the configuration for machine learning model monitoring and reporting; evaluating the one or more machine learning functionality configurations based, at least partially, on the monitoring of the one or more machine learning functionality configurations; and determining at least one configuration for performing handover based, at least partially, on the evaluating of the one or more machine learning functionality configurations, wherein the at least one determined configuration for performing handover may comprise one of: a non-machine learning configuration, or at least one machine learning functionality configuration of the one or more machine learning functionality configurations.

A computer implemented system comprising: at least one processor and at least one non-transitory memory storing instructions that, when executed by the at least one processor, cause the system at least to perform: causing receiving, from a source cell, of a handover command, wherein the handover command may comprise: at least one handover condition, and a configuration for machine learning model monitoring and reporting; monitoring one or more machine learning functionality configurations for at least one target cell based, at least partially, on the configuration for machine learning model monitoring and reporting; evaluating the one or more machine learning functionality configurations based, at least partially, on the monitoring of the one or more machine learning functionality configurations; and determining at least one configuration for performing handover based, at least partially, on the evaluating of the one or more machine learning functionality configurations, wherein the at least one determined configuration for performing handover may comprise one of: a non-machine learning configuration, or at least one machine learning functionality configuration of the one or more machine learning functionality configurations.

A computer implemented system comprising: means for causing receiving, from a source cell, of a handover command, wherein the handover command may comprise: at least one handover condition, and a configuration for machine learning model monitoring and reporting; means for monitoring one or more machine learning functionality configurations for at least one target cell based, at least partially, on the configuration for machine learning model monitoring and reporting; means for evaluating the one or more machine learning functionality configurations based, at least partially, on the monitoring of the one or more machine learning functionality configurations; and means for determining at least one configuration for performing handover based, at least partially, on the evaluating of the one or more machine learning functionality configurations, wherein the at least one determined configuration for performing handover may comprise one of: a non-machine learning configuration, or at least one machine learning functionality configuration of the one or more machine learning functionality configurations.

In accordance with one example embodiment, an apparatus may comprise: at least one processor; and at least one memory storing instructions that, when executed by the at least one processor, cause the apparatus at least to: transmit, to at least one target cell, a handover request; receive, from the at least one target cell, an acknowledgement of the handover request, wherein the acknowledgement may comprise, at least one of: an indication of one or more resources for monitoring one or more machine learning functionality configurations, or an indication of a criteria for evaluating the one or more machine learning functionality configurations; determine a configuration for machine learning model monitoring and reporting based, at least partially, on the acknowledgement of the handover request; and transmit, to a user equipment, a handover command, wherein the handover command may comprise: at least one handover condition, and the configuration for machine learning model monitoring and reporting.

The handover request may comprise at least one of: an indication of machine learning functionality capabilities of the apparatus, an indication of machine learning functionality capabilities of the user equipment, or an indication of at least one machine learning functionality configuration supported by the user equipment.

Determining the configuration for machine learning model monitoring and reporting may comprise the example apparatus being further configured to: modify at least one of the criteria for evaluating the one or more machine learning functionality configurations.

The configuration for machine learning model monitoring and reporting may comprise at least one of: an indication of a trigger condition for performing monitoring, an indication of when to perform monitoring, an indication of a metric for the evaluating, an indication of a threshold for the evaluating, an indication of when to report results of the evaluating, or an indication of at least one resource for reporting the results of the evaluating.

The indication of when to report the results of the evaluating may comprise at least one of: an indication of repetition pattern for reporting the results of the evaluating, or an indication of an event configured to trigger reporting the results of the evaluating.

The indication of when to report the results of the evaluating may comprise an indication of a threshold value for a comparison of a reference signal received power of the at least one target cell with a reference signal received power of the source cell.

The configuration for machine learning model monitoring and reporting may comprise an indication of a non-machine learning configuration.

The at least one handover condition may be associated with the one or more machine learning functionality configurations, wherein the configuration for machine learning model monitoring and reporting may be associated with the one or more machine learning functionality configurations.

The example apparatus may be further configured to: receive, from the user equipment, at least one result of evaluation of the one or more machine learning functionality configurations.

The at least one result may comprise at least one of: an intermediate result, or a final result.

The example apparatus may be further configured to: transmit, to the at least one target cell, the at least one result of evaluation of the one or more machine learning functionality configurations.

The example apparatus may be further configured to: receive, from the at least one target cell, an update to the one or more machine learning functionality configurations.

The example apparatus may be further configured to: transmit, to the user equipment, at least one reconfiguration based, at least partially, on the received update to the one or more machine learning functionality configurations.

The at least one reconfiguration may be configured to at least one of: add at least one machine learning functionality configuration to the one or more machine learning functionality configurations, remove at least one machine learning functionality configuration to the one or more machine learning functionality configurations, add at least one resource for monitoring the one or more machine learning functionality configurations, or remove at least one resource for monitoring the one or more machine learning functionality configurations.

The example apparatus may be further configured to: receive, from the at least one target cell, a handover report comprising at least one result from handover of the user equipment to the at least one target cell.

The example apparatus may be further configured to: receive, from the user equipment, at least one of: an indication of a configuration to be used for performing handover, an evaluation for respective ones of the one or more machine learning functionality configurations, or an indication of at least one of the one or more machine learning functionality configurations that is not to be used for handover.

In accordance with one aspect, an example method may be provided comprising: transmitting, with a source base station to at least one target cell, a handover request; receiving, from the at least one target cell, an acknowledgement of the handover request, wherein the acknowledgement may comprise, at least one of: an indication of one or more resources for monitoring one or more machine learning functionality configurations, or an indication of a criteria for evaluating the one or more machine learning functionality configurations; determining a configuration for machine learning model monitoring and reporting based, at least partially, on the acknowledgement of the handover request; and transmitting, to a user equipment, a handover command, wherein the handover command may comprise: at least one handover condition, and the configuration for machine learning model monitoring and reporting.

The handover request may comprise at least one of: an indication of machine learning functionality capabilities of the source base station, an indication of machine learning functionality capabilities of the user equipment, or an indication of at least one machine learning functionality configuration supported by the user equipment.

The determining of the configuration for machine learning model monitoring and reporting may comprise: modifying at least one of the criteria for evaluating the one or more machine learning functionality configurations.

The configuration for machine learning model monitoring and reporting may comprise at least one of: an indication of a trigger condition for performing monitoring, an indication of when to perform monitoring, an indication of a metric for the evaluating, an indication of a threshold for the evaluating, an indication of when to report results of the evaluating, or an indication of at least one resource for reporting the results of the evaluating.

The indication of when to report the results of the evaluating may comprise at least one of: an indication of repetition pattern for reporting the results of the evaluating, or an indication of an event configured to trigger reporting the results of the evaluating.

The indication of when to report the results of the evaluating may comprise an indication of a threshold value for a comparison of a reference signal received power of the at least one target cell with a reference signal received power of the source cell.

The configuration for machine learning model monitoring and reporting may comprise an indication of a non-machine learning configuration.

The at least one handover condition may be associated with the one or more machine learning functionality configurations, wherein the configuration for machine learning model monitoring and reporting may be associated with the one or more machine learning functionality configurations.

The example method may further comprise: receiving, from the user equipment, at least one result of evaluation of the one or more machine learning functionality configurations.

The at least one result may comprise at least one of: an intermediate result, or a final result.

The example method may further comprise: transmitting, to the at least one target cell, the at least one result of evaluation of the one or more machine learning functionality configurations.

The example method may further comprise: receiving, from the at least one target cell, an update to the one or more machine learning functionality configurations.

The example method may further comprise: transmitting, to the user equipment, at least one reconfiguration based, at least partially, on the received update to the one or more machine learning functionality configurations.

The at least one reconfiguration may be configured to at least one of: add at least one machine learning functionality configuration to the one or more machine learning functionality configurations, remove at least one machine learning functionality configuration to the one or more machine learning functionality configurations, add at least one resource for monitoring the one or more machine learning functionality configurations, or remove at least one resource for monitoring the one or more machine learning functionality configurations.

The example method may further comprise: receiving, from the at least one target cell, a handover report comprising at least one result from handover of the user equipment to the at least one target cell.

The example method may further comprise: receiving, from the user equipment, at least one of: an indication of a configuration to be used for performing handover, an evaluation for respective ones of the one or more machine learning functionality configurations, or an indication of at least one of the one or more machine learning functionality configurations that is not to be used for handover.

In accordance with one example embodiment, an apparatus may comprise: circuitry configured to perform: transmitting, to at least one target cell, a handover request; circuitry configured to perform: receiving, from the at least one target cell, an acknowledgement of the handover request, wherein the acknowledgement may comprise, at least one of: an indication of one or more resources for monitoring one or more machine learning functionality configurations, or an indication of a criteria for evaluating the one or more machine learning functionality configurations; circuitry configured to perform: determining a configuration for machine learning model monitoring and reporting based, at least partially, on the acknowledgement of the handover request; and circuitry configured to perform: transmitting, to a user equipment, a handover command, wherein the handover command may comprise: at least one handover condition, and the configuration for machine learning model monitoring and reporting.

In accordance with one example embodiment, an apparatus may comprise: processing circuitry; memory circuitry including computer program code, the memory circuitry and the computer program code configured to, with the processing circuitry, enable the apparatus to: transmit, to at least one target cell, a handover request; receive, from the at least one target cell, an acknowledgement of the handover request, wherein the acknowledgement may comprise, at least one of: an indication of one or more resources for monitoring one or more machine learning functionality configurations, or an indication of a criteria for evaluating the one or more machine learning functionality configurations; determine a configuration for machine learning model monitoring and reporting based, at least partially, on the acknowledgement of the handover request; and transmit, to a user equipment, a handover command, wherein the handover command may comprise: at least one handover condition, and the configuration for machine learning model monitoring and reporting.

In accordance with one example embodiment, an apparatus may comprise means for: transmitting, to at least one target cell, a handover request; receiving, from the at least one target cell, an acknowledgement of the handover request, wherein the acknowledgement may comprise, at least one of: an indication of one or more resources for monitoring one or more machine learning functionality configurations, or an indication of a criteria for evaluating the one or more machine learning functionality configurations; determining a configuration for machine learning model monitoring and reporting based, at least partially, on the acknowledgement of the handover request; and transmitting, to a user equipment, a handover command, wherein the handover command may comprise: at least one handover condition, and the configuration for machine learning model monitoring and reporting.

The handover request may comprise at least one of: an indication of machine learning functionality capabilities of the apparatus, an indication of machine learning functionality capabilities of the user equipment, or an indication of at least one machine learning functionality configuration supported by the user equipment.

The means configured for determining the configuration for machine learning model monitoring and reporting may comprise means configured for: modifying at least one of the criteria for evaluating the one or more machine learning functionality configurations.

The configuration for machine learning model monitoring and reporting may comprise at least one of: an indication of a trigger condition for performing monitoring, an indication of when to perform monitoring, an indication of a metric for the evaluating, an indication of a threshold for the evaluating, an indication of when to report results of the evaluating, or an indication of at least one resource for reporting the results of the evaluating.

The indication of when to report the results of the evaluating may comprise at least one of: an indication of repetition pattern for reporting the results of the evaluating, or an indication of an event configured to trigger reporting the results of the evaluating.

The indication of when to report the results of the evaluating may comprise an indication of a threshold value for a comparison of a reference signal received power of the at least one target cell with a reference signal received power of the source cell.

The configuration for machine learning model monitoring and reporting may comprise an indication of a non-machine learning configuration.

The at least one handover condition may be associated with the one or more machine learning functionality configurations, wherein the configuration for machine learning model monitoring and reporting may be associated with the one or more machine learning functionality configurations.

The means may be further configured for: receiving, from the user equipment, at least one result of evaluation of the one or more machine learning functionality configurations.

The at least one result may comprise at least one of: an intermediate result, or a final result.

The means may be further configured for: transmitting, to the at least one target cell, the at least one result of evaluation of the one or more machine learning functionality configurations.

The means may be further configured for: receiving, from the at least one target cell, an update to the one or more machine learning functionality configurations.

The means may be further configured for: transmitting, to the user equipment, at least one reconfiguration based, at least partially, on the received update to the one or more machine learning functionality configurations.

The at least one reconfiguration may be configured to at least one of: add at least one machine learning functionality configuration to the one or more machine learning functionality configurations, remove at least one machine learning functionality configuration to the one or more machine learning functionality configurations, add at least one resource for monitoring the one or more machine learning functionality configurations, or remove at least one resource for monitoring the one or more machine learning functionality configurations.

The means may be further configured for: receiving, from the at least one target cell, a handover report comprising at least one result from handover of the user equipment to the at least one target cell.

The means may be further configured for: receiving, from the user equipment, at least one of: an indication of a configuration to be used for performing handover, an evaluation for respective ones of the one or more machine learning functionality configurations, or an indication of at least one of the one or more machine learning functionality configurations that is not to be used for handover.

In accordance with one example embodiment, a non-transitory computer-readable medium comprising instructions stored thereon which, when executed with at least one processor, cause the at least one processor to: cause transmitting, to at least one target cell, of a handover request; cause receiving, from the at least one target cell, of an acknowledgement of the handover request, wherein the acknowledgement may comprise, at least one of: an indication of one or more resources for monitoring one or more machine learning functionality configurations, or an indication of a criteria for evaluating the one or more machine learning functionality configurations; determine a configuration for machine learning model monitoring and reporting based, at least partially, on the acknowledgement of the handover request; and cause transmitting, to a user equipment, of a handover command, wherein the handover command may comprise: at least one handover condition, and the configuration for machine learning model monitoring and reporting.

In accordance with one example embodiment, a non-transitory computer-readable medium comprising program instructions stored thereon for performing at least the following: causing transmitting, to at least one target cell, of a handover request; causing receiving, from the at least one target cell, of an acknowledgement of the handover request, wherein the acknowledgement may comprise, at least one of: an indication of one or more resources for monitoring one or more machine learning functionality configurations, or an indication of a criteria for evaluating the one or more machine learning functionality configurations; determining a configuration for machine learning model monitoring and reporting based, at least partially, on the acknowledgement of the handover request; and causing transmitting, to a user equipment, of a handover command, wherein the handover command may comprise: at least one handover condition, and the configuration for machine learning model monitoring and reporting.

In accordance with another example embodiment, a non-transitory program storage device readable by a machine may be provided, tangibly embodying instructions executable by the machine for performing operations, the operations comprising: causing transmitting, to at least one target cell, of a handover request; causing receiving, from the at least one target cell, of an acknowledgement of the handover request, wherein the acknowledgement may comprise, at least one of: an indication of one or more resources for monitoring one or more machine learning functionality configurations, or an indication of a criteria for evaluating the one or more machine learning functionality configurations; determining a configuration for machine learning model monitoring and reporting based, at least partially, on the acknowledgement of the handover request; and causing transmitting, to a user equipment, of a handover command, wherein the handover command may comprise: at least one handover condition, and the configuration for machine learning model monitoring and reporting.

In accordance with another example embodiment, a non-transitory computer-readable medium comprising instructions that, when executed by an apparatus, cause the apparatus to perform at least the following: causing transmitting, to at least one target cell, of a handover request; causing receiving, from the at least one target cell, of an acknowledgement of the handover request, wherein the acknowledgement may comprise, at least one of: an indication of one or more resources for monitoring one or more machine learning functionality configurations, or an indication of a criteria for evaluating the one or more machine learning functionality configurations; determining a configuration for machine learning model monitoring and reporting based, at least partially, on the acknowledgement of the handover request; and causing transmitting, to a user equipment, of a handover command, wherein the handover command may comprise: at least one handover condition, and the configuration for machine learning model monitoring and reporting.

A computer implemented system comprising: at least one processor and at least one non-transitory memory storing instructions that, when executed by the at least one processor, cause the system at least to perform: causing transmitting, to at least one target cell, of a handover request; causing receiving, from the at least one target cell, of an acknowledgement of the handover request, wherein the acknowledgement may comprise, at least one of: an indication of one or more resources for monitoring one or more machine learning functionality configurations, or an indication of a criteria for evaluating the one or more machine learning functionality configurations; determining a configuration for machine learning model monitoring and reporting based, at least partially, on the acknowledgement of the handover request; and causing transmitting, to a user equipment, of a handover command, wherein the handover command may comprise: at least one handover condition, and the configuration for machine learning model monitoring and reporting.

A computer implemented system comprising: means for causing transmitting, to at least one target cell, of a handover request; causing receiving, from the at least one target cell, of an acknowledgement of the handover request, wherein the acknowledgement may comprise, at least one of: an indication of one or more resources for monitoring one or more machine learning functionality configurations, or an indication of a criteria for evaluating the one or more machine learning functionality configurations; means for determining a configuration for machine learning model monitoring and reporting based, at least partially, on the acknowledgement of the handover request; and means for causing transmitting, to a user equipment, of a handover command, wherein the handover command may comprise: at least one handover condition, and the configuration for machine learning model monitoring and reporting.

In accordance with one example embodiment, an apparatus may comprise: at least one processor; and at least one memory storing instructions that, when executed by the at least one processor, cause the apparatus at least to: receive, from a source cell, a handover request; and transmit, to the source cell, an acknowledgement of the handover request, wherein the acknowledgement may comprise, at least one of: an indication of one or more resources for monitoring one or more machine learning functionality configurations, or an indication of a criteria for evaluating the one or more machine learning functionality configurations.

The handover request may comprise at least one of: an indication of machine learning functionality capabilities of the source cell, an indication of machine learning functionality capabilities of a user equipment, or an indication of at least one machine learning functionality configuration supported by the user equipment.

The example apparatus may be further configured to: receive, from the source cell, at least one result of evaluation of the one or more machine learning functionality configurations.

The at least one result may comprise at least one of: an intermediate result, or a final result.

The example apparatus may be further configured to: determine to update at least one of the one or more resources for monitoring the one or more machine learning functionality configurations based, at least partially, on the at least one result of evaluation of the one or more machine learning functionality configurations.

The example apparatus may be further configured to: release the at least one of the one or more resources for monitoring the one or more machine learning functionality configurations.

The example apparatus may be further configured to: transmit, to the source cell, an update to the one or more machine learning functionality configurations.

The example apparatus may be further configured to: perform handover with a user equipment from the source cell; and transmit, to the source cell, a handover report comprising at least one result from the handover.

In accordance with one aspect, an example method may be provided comprising: receiving, with a target base station from a source cell, a handover request; and transmitting, to the source cell, an acknowledgement of the handover request, wherein the acknowledgement may comprise, at least one of: an indication of one or more resources for monitoring one or more machine learning functionality configurations, or an indication of a criteria for evaluating the one or more machine learning functionality configurations.

The handover request may comprise at least one of: an indication of machine learning functionality capabilities of the source cell, an indication of machine learning functionality capabilities of a user equipment, or an indication of at least one machine learning functionality configuration supported by the user equipment.

The example method may further comprise: receiving, from the source cell, at least one result of evaluation of the one or more machine learning functionality configurations.

The at least one result may comprise at least one of: an intermediate result, or a final result.

The example method may further comprise: determining to update at least one of the one or more resources for monitoring the one or more machine learning functionality configurations based, at least partially, on the at least one result of evaluation of the one or more machine learning functionality configurations.

The example method may further comprise: releasing the at least one of the one or more resources for monitoring the one or more machine learning functionality configurations.

The example method may further comprise: transmitting, to the source cell, an update to the one or more machine learning functionality configurations.

The example method may further comprise: performing handover with a user equipment from the source cell; and transmitting, to the source cell, a handover report comprising at least one result from the handover.

In accordance with one example embodiment, an apparatus may comprise: circuitry configured to perform: receiving, with a target base station from a source cell, a handover request; and circuitry configured to perform: transmitting, to the source cell, an acknowledgement of the handover request, wherein the acknowledgement may comprise, at least one of: an indication of one or more resources for monitoring one or more machine learning functionality configurations, or an indication of a criteria for evaluating the one or more machine learning functionality configurations.

In accordance with one example embodiment, an apparatus may comprise: processing circuitry; memory circuitry including computer program code, the memory circuitry and the computer program code configured to, with the processing circuitry, enable the apparatus to: receive, from a source cell, a handover request; and transmit, to the source cell, an acknowledgement of the handover request, wherein the acknowledgement may comprise, at least one of: an indication of one or more resources for monitoring one or more machine learning functionality configurations, or an indication of a criteria for evaluating the one or more machine learning functionality configurations.

In accordance with one example embodiment, an apparatus may comprise means for: receiving, from a source cell, a handover request; and transmitting, to the source cell, an acknowledgement of the handover request, wherein the acknowledgement may comprise, at least one of: an indication of one or more resources for monitoring one or more machine learning functionality configurations, or an indication of a criteria for evaluating the one or more machine learning functionality configurations.

The handover request may comprise at least one of: an indication of machine learning functionality capabilities of the source cell, an indication of machine learning functionality capabilities of a user equipment, or an indication of at least one machine learning functionality configuration supported by the user equipment.

The means may be further configured for: receiving, from the source cell, at least one result of evaluation of the one or more machine learning functionality configurations.

The at least one result may comprise at least one of: an intermediate result, or a final result.

The means may be further configured for: determining to update at least one of the one or more resources for monitoring the one or more machine learning functionality configurations based, at least partially, on the at least one result of evaluation of the one or more machine learning functionality configurations.

The means may be further configured for: releasing the at least one of the one or more resources for monitoring the one or more machine learning functionality configurations.

The means may be further configured for: transmitting, to the source cell, an update to the one or more machine learning functionality configurations.

The means may be further configured for: performing handover with a user equipment from the source cell; and transmitting, to the source cell, a handover report comprising at least one result from the handover.

In accordance with one example embodiment, a non-transitory computer-readable medium comprising instructions stored thereon which, when executed with at least one processor, cause the at least one processor to: cause receiving, from a source cell, of a handover request; and cause transmitting, to the source cell, of an acknowledgement of the handover request, wherein the acknowledgement may comprise, at least one of: an indication of one or more resources for monitoring one or more machine learning functionality configurations, or an indication of a criteria for evaluating the one or more machine learning functionality configurations.

In accordance with one example embodiment, a non-transitory computer-readable medium comprising program instructions stored thereon for performing at least the following: causing receiving, from a source cell, of a handover request; and causing transmitting, to the source cell, of an acknowledgement of the handover request, wherein the acknowledgement may comprise, at least one of: an indication of one or more resources for monitoring one or more machine learning functionality configurations, or an indication of a criteria for evaluating the one or more machine learning functionality configurations.

In accordance with another example embodiment, a non-transitory program storage device readable by a machine may be provided, tangibly embodying instructions executable by the machine for performing operations, the operations comprising: causing receiving, from a source cell, of a handover request; and causing transmitting, to the source cell, of an acknowledgement of the handover request, wherein the acknowledgement may comprise, at least one of: an indication of one or more resources for monitoring one or more machine learning functionality configurations, or an indication of a criteria for evaluating the one or more machine learning functionality configurations.

In accordance with another example embodiment, a non-transitory computer-readable medium comprising instructions that, when executed by an apparatus, cause the apparatus to perform at least the following: causing receiving, from a source cell, of a handover request; and causing transmitting, to the source cell, of an acknowledgement of the handover request, wherein the acknowledgement may comprise, at least one of: an indication of one or more resources for monitoring one or more machine learning functionality configurations, or an indication of a criteria for evaluating the one or more machine learning functionality configurations.

A computer implemented system comprising: at least one processor and at least one non-transitory memory storing instructions that, when executed by the at least one processor, cause the system at least to perform: causing receiving, from a source cell, of a handover request; and causing transmitting, to the source cell, of an acknowledgement of the handover request, wherein the acknowledgement may comprise, at least one of: an indication of one or more resources for monitoring one or more machine learning functionality configurations, or an indication of a criteria for evaluating the one or more machine learning functionality configurations.

A computer implemented system comprising: means for causing receiving, from a source cell, of a handover request; and means for causing transmitting, to the source cell, of an acknowledgement of the handover request, wherein the acknowledgement may comprise, at least one of: an indication of one or more resources for monitoring one or more machine learning functionality configurations, or an indication of a criteria for evaluating the one or more machine learning functionality configurations.

The term “non-transitory,” as used herein, is a limitation of the medium itself (i.e. tangible, not a signal) as opposed to a limitation on data storage persistency (e.g., RAM vs. ROM).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1. An apparatus comprising:
at least one processor; and
at least one non-transitory memory storing instructions that, when executed by
the at least one processor, cause the apparatus at least to:
receive, from a source cell, a handover command, wherein the handover command comprises:
at least one handover condition, and
a configuration for machine learning model monitoring and reporting;
monitor one or more machine learning functionality configurations for at least one target cell based, at least partially, on the configuration for machine learning model monitoring and reporting;
evaluate the one or more machine learning functionality configurations based, at least partially, on the monitoring of the one or more machine learning functionality configurations; and
determine at least one configuration for performing handover based, at least partially, on the evaluating of the one or more machine learning functionality configurations, wherein the at least one determined configuration for performing the handover comprises one of:
a non-machine learning configuration, or
at least one machine learning functionality configuration of the one or more machine learning functionality configurations.

2. The apparatus of claim 1, wherein the configuration for machine learning model monitoring and reporting comprises at least one of:
an indication of a trigger condition for performing monitoring,
an indication of when to perform monitoring,
an indication of a metric for the evaluating,
an indication of a threshold for the evaluating,
an indication of when to report results of the evaluating, or
an indication of at least one resource for reporting the results of the evaluating.

3. The apparatus of claim 2, wherein the indication of when to report the results of the evaluating comprises at least one of:
an indication of repetition pattern for reporting the results of the evaluating, or
an indication of an event configured to trigger reporting the results of the evaluating.

4. The apparatus of claim 3, wherein the indication of when to report the results of the evaluating comprises an indication of a threshold value for a comparison of a reference signal received power of the at least one target cell with a reference signal received power of the source cell.

5. The apparatus of claim 4, wherein the configuration for machine learning model monitoring and reporting comprises an indication of the non-machine learning configuration.

6. The apparatus of claim 5, wherein the at least one memory stores instructions that, when executed by the at least one processor, cause the apparatus to:
receive, from the source cell, at least one reconfiguration, wherein the monitoring of the one or more machine learning functionality configurations is further based on the at least one reconfiguration.

7. The apparatus of claim 6, wherein the at least one memory stores instructions that, when executed by the at least one processor, cause the apparatus to:
adapt the monitoring of the one or more machine learning functionality configurations based, at least partially, on at least one intermediate result of the monitoring, wherein adapting the monitoring comprises the at least one memory stores instructions that, when executed by the at least one processor, cause the apparatus to at least one of:
adapt a time window for the monitoring of the one or more machine learning functionality configurations; or
adapt a frequency for the monitoring of the one or more machine learning functionality configurations.

8. (canceled)

9. The apparatus of claim 7, wherein the at least one configuration for performing the handover is determined to be the non-machine learning configuration based, at least partially, on the evaluating of the one or more machine learning functionality configurations resulting in a determination that the one or more machine learning functionality configurations are not valid for the at least one target cell.

10. The apparatus of claim 9, wherein the at least one handover condition is associated with the one or more machine learning functionality configurations, wherein the configuration for machine learning model monitoring and reporting is associated with the one or more machine learning functionality configurations.

11. The apparatus of claim 10, wherein the at least one memory stores instructions that, when executed by the at least one processor, cause the apparatus to:
determine that the at least one handover condition has been met; and
in response to the determination that the at least one handover condition has been met, perform the handover to the at least one target cell using the determined configuration.

12. The apparatus of claim 11, wherein the at least one memory stores instructions that, when executed by the at least one processor, cause the apparatus to:
transmit, to the source cell, at least one result of the evaluating of the one or more machine learning functionality configurations, wherein the at least one result comprises at least one of:
an intermediate result, or
a final result.

13.-15. (canceled)

16. The apparatus of claim 12, wherein the at least one memory stores instructions that, when executed by the at least one processor, cause the apparatus to:
transmit, to the source cell, at least one of:
an indication of the at least one determined configuration for performing the handover,
an evaluation for respective ones of the one or more machine learning functionality configurations, or
an indication of at least one of the one or more machine learning functionality configurations that is not to be used for the handover.

17. (canceled)

18. (canceled)

19. An apparatus comprising:
at least one processor; and
at least one non-transitory memory storing instructions that, when executed by the at least one processor, cause the apparatus at least to:
transmit, to at least one target cell, a handover request;
receive, from the at least one target cell, an acknowledgement of the handover request, wherein the acknowledgement comprises, at least one of:
an indication of one or more resources for monitoring one or more machine learning functionality configurations, or
an indication of a criteria for evaluating the one or more machine learning functionality configurations;
determine a configuration for machine learning model monitoring and reporting based, at least partially, on the acknowledgement of the handover request; and
transmit, to a user equipment, a handover command, wherein the handover command comprises:
at least one handover condition, and
the configuration for machine learning model monitoring and reporting.

20. The apparatus of claim 19, wherein the handover request comprises at least one of:
an indication of machine learning functionality capabilities of the apparatus,
an indication of machine learning functionality capabilities of the user equipment, or
an indication of at least one machine learning functionality configuration supported by the user equipment.

21. The apparatus of claim 20, wherein determining the configuration for machine learning model monitoring and reporting comprises the at least one memory stores instructions that, when executed by the at least one processor, cause the apparatus to:
modify at least one of the criteria for evaluating the one or more machine learning functionality configurations.

22. The apparatus of claim 21, wherein the configuration for machine learning model monitoring and reporting comprises at least one of:
an indication of a trigger condition for performing monitoring,
an indication of when to perform monitoring,
an indication of a metric for the evaluating,
an indication of a threshold for the evaluating,
an indication of when to report results of the evaluating, or
an indication of at least one resource for reporting the results of the evaluating.

23.-36. (canceled)

37. An apparatus comprising:
at least one processor; and
at least one non-transitory memory storing instructions that, when executed by the at least one processor, cause the apparatus at least to:
receive, from a source cell, a handover request; and
transmit, to the source cell, an acknowledgement of the handover request, wherein the acknowledgement comprises, at least one of:
an indication of one or more resources for monitoring one or more machine learning functionality configurations, or
an indication of a criteria for evaluating the one or more machine learning functionality configurations.

38. The apparatus of claim 37, wherein the handover request comprises at least one of:
an indication of machine learning functionality capabilities of the source cell,
an indication of machine learning functionality capabilities of a user equipment, or
an indication of at least one machine learning functionality configuration supported by the user equipment.

39. The apparatus claim 38, wherein the at least one memory stores instructions that, when executed by the at least one processor, cause the apparatus to:
receive, from the source cell, at least one result of evaluation of the one or more machine learning functionality configurations, wherein the at least one result comprises at least one of:
an intermediate result, or
a final result.

40. (canceled)

41. The apparatus of claim 39, wherein the at least one memory stores instructions that, when executed by the at least one processor, cause the apparatus to:
determine to update at least one of the one or more resources for monitoring the one or more machine learning functionality configurations based, at least partially, on the at least one result of evaluation of the one or more machine learning functionality configurations;
release the at least one of the one or more resources for monitoring the one or more machine learning functionality configurations; and
transmit, to the source cell, an update to the one or more machine learning functionality configurations.

42.-46. (canceled)
